(19) United States
(12) Patent Application Publication
(10) Pub. No.: US 2024/0126008 A1
(43) Pub. Date: Apr. 18, 2024

(54) COMPOSITE MATERIAL WITH SIDE-EMITTING OPTICAL FIBERS

(71) Applicants: Paul K. Westerhoff, Scottsdale, AZ (US); Hojung Rho, Seoul (KR)

(72) Inventors: Paul K. Westerhoff, Scottsdale, AZ (US); Hojung Rho, Seoul (KR)

(21) Appl. No.: 18/482,265

(22) Filed: Oct. 6, 2023

Related U.S. Application Data
(60) Provisional application No. 63/378,614, filed on Oct. 6, 2022.

(51) Int. Cl. G02B 6/02; B01D 61/08; C03C 25/104

(52) U.S. Cl. CPC G02B 6/02; B01D 61/08; C03C 25/104

(57) ABSTRACT

A composite material includes one or more side-emitting optical fibers arranged in a pattern defining openings bounded at least in part by the one or more side-emitting optical fibers. The one or more side-emitting optical fibers have a UV-C transparent coating, and at least one of the one or more side-emitting optical fibers is configured to be coupled to a light-emitting diode. A reverse osmosis filter includes a reverse osmosis membrane and the composite material coupled to the reverse osmosis membrane.

### CROSS-REFERENCE TO RELATED APPLICATION

This application claims the benefit of U.S. Patent Application No. 63/378,614 filed on Oct. 6, 2022, which is incorporated by reference herein in its entirety.

### STATEMENT OF GOVERNMENT SUPPORT

This invention was made with government support under 1449500 awarded by the National Science Foundation. The government has certain rights in the invention.

### TECHNICAL FIELD

This invention relates to side-emitting optical fibers (e.g., for use in reverse osmosis filters).

### BACKGROUND

Reverse osmosis (RO) membranes are used in water, wastewater, reuse, and industrial water treatment and applications. RO feed spacers provide support to RO membranes in spirally wound RO membrane elements. RO feed spacers also provide gaps between the membrane layers to promote turbulence and reduce the deposition of particles (e.g., inorganic sealants) or foulants (e.g., organics and microbial). Feed spacers help to reduce but do not eliminate biofouling.

### SUMMARY

This disclosure describes side-emitting optical fibers (SEOFs) formed into spacers for use in reverse osmosis (RO) water filters to mitigate biofouling on RO membranes. RO membrane spacers are positioned between layers of RO membranes in spirally wound filters to provide mechanical support and promote fluid turbulence. This disclosure describes forming one or more SEOFs, optionally coated with silica nanoparticles, into a spacer that is patterned to permit a through-flow of water (e.g., a mesh sheet). The SEOF spacer can then be spirally wound in direct contact with the RO membrane, and can be optically coupled on the exterior of the filter to a light-emitting diode (LED). The SEOFs of the spacer provide UV-C light to the RO membrane surface to mitigate biofouling (e.g., the growth of biofilms).

In a first general aspect, a composite material includes one or more side-emitting optical fibers arranged in a pattern defining openings bounded at least in part by the one or more side-emitting optical fibers, wherein the one or more side-emitting optical fibers have a UV-C transparent coating, and at least one of the one or more side-emitting optical fibers is configured to be coupled to a light-emitting diode.

Implementations of the first general aspect may include one or more of the following features.

The composite material may include a woven or non-woven fabric of the one or more side-emitting optical fibers. In some cases, the one or more side-emitting optical fibers have a diameter in a range of about 100 μm to about 1000 μm. In certain cases, a length of the one or more side-emitting optical fibers is in a range of about 20 cm to about 1 km.

The pattern can include a mesh, a lattice, a matrix, or a network. The openings can have a geometrical shape (e.g., a rectangle or a parallelogram). A linear dimension of each opening typically exceeds a diameter of the one or more side-emitting optical fibers.

The composite material is typically in the form of a sheet. In some cases, a thickness of the sheet is in a range of about 0.5 mm to about 1.5 mm.

In some cases, the one or more side-emitting optical fibers includes a multiplicity of bundled side-emitting optical fibers.

In a second general aspect, a filter includes the composite material of the first general aspect.

In a third general aspect, a water tank comprising the composite material of the first general aspect.

In a fourth general aspect, a spacer for a reverse osmosis filter includes the composite material of the first general aspect.

In a fifth general aspect, a reverse osmosis filter includes a reverse osmosis membrane and the composite material of the first general aspect coupled to the reverse osmosis membrane.

Implementations of the fifth general aspect may include one or more of the following features.

The composite material can be in direct contact with the reverse osmosis membrane. The reverse osmosis membrane and the composite material are spirally wound. The composite material provides gaps between layers of the reverse osmosis membrane. The gaps promote turbulence in a fluid flowing through the filter.

In some cases, the reverse osmosis filter includes a UV-C light-emitting diode exterior to the reverse osmosis filter and optically coupled to one or more of the side-emitting optical fibers.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts a first embodiment of a spiral wound reverse osmosis (RO) membrane filter module that integrates side-emitting optical fibers (SEOFs) as spacers.

FIG. 2 depicts a second embodiment of a spiral wound RO membrane filter module with flexible SEOFs as spacers within the spiral-wound RO membrane module.

FIGS. 3A and 3B depict SEOFs coated with silica nanoparticles and TiO₂ nanoparticles, respectively, and mitigation of biofouling on the surface of an RO membrane.

FIG. 4 depicts a pattern suitable for an RO spacer formed of SEOFs.

FIG. 5 depicts the fabrication steps for UV-C and UV-A SEOFs for disinfection and photocatalytic oxidation.

FIG. 6A depicts a RO membrane test apparatus equipped with two SEOFs. The membrane cell is fully enclosed with a cross-flow of water through the chamber. FIG. 6B depicts the membrane cell configured within a temperature-controlled recirculating system.

FIG. 7A shows a distribution of UV-C and UV-A light intensity along fiber surfaces.

FIG. 7B shows quantification of ⋅OH produced from UV-A SEOFs using p-HBA method.

FIGS. 8A-8C show biofouling propensities of lab-scale of RO membrane unit with UV-A and UV-C LED and without LED. FIG. 8A shows flux decline during 8 days by biofouling. FIG. 8B shows salt rejections during the operations. FIG. 8C shows thickness of fouling layer measured by optical coherence tomography (OCT) images.

FIGS. 9A and 9B show plots of surface properties of virgin and fouled RO membranes. FIG. 9A shows surface zeta potential measured in 10 mM of KCl electrolyte solution. FIG. 9B shows contact angle of RO membrane measured using 10 μL of deionized (DI) water.

FIGS. 10A and 10B show plots characterizing biofoulants extracted from fouled RO membranes. FIG. 10A shows CFU counts and live-cell viability, and FIG. 10B shows extracellular polymeric substance (EPS) quantification.

FIG. 11 shows a plot of the transcriptomic analysis for P. aeruginosa exposed to UV-C and UV-A SEOFs. Error bars represent±one standard deviation from the mean of triplicate measurements.

FIG. 12A depicts an experimental setup for growing biofilm in a 50-cm-long reactor with irradiation from a single SEOF delivering UV-C light from one end or both ends. FIGS. 12B and 12C show UV-C irradiance from an LED on one end or LEDs on both ends, respectively, measured at different distances from and along the length of the single SEOF.

FIGS. 13A-13D show UV-C irradiance (I_{SEOF}) measured at the SEOF surface (square symbols and lines) and biofilm thickness over time (1, 2 and 3 days) along the length of the reactors (L=0 is the influent proximal end) and adjacent to the SEOF (d=0 cm) for control reactor in the dark (SEOF without an LED), reactor with SEOF connected to one LED, reactor with SEOF connected to 2 LEDs adjacent to the SEOF (d=0 cm offset), and reactor with SEOF connected to 2 LEDs at d=2 cm offset perpendicular from the SEOF, respectively.

FIG. 14 shows biofilm specific growth rates in the 50-cm reactor where SEOFs delivered different UV-C irradiance to the reactor surface. The shaded region represents the average and 95% confidence interval (μ=0.34±0.06 d⁻¹) of the specific growth rates when biofilm was effectively inhibited, partly inhibited, and poorly inhibited.

FIGS. 15A-15C depict P. aeruginosa biofilm response to UV-C irradiation: continuous UV-C irradiance that poorly inhibited (UV-C<3 μW/cm²), and effectively inhibited (8 μW/cm²<UV-C<80 μW/cm²) biofilm growth: and P. aeruginosa biofilm response to post-treatment by >250 μW/cm² UV-C light for 30 min, respectively.

FIG. 16 is a schematic of pipeloop apparatus showing feedwater tank containing P. aeruginosa in 10× diluted M9 medium and five parallel tube reactors for continuous flow (200 mL/min through each tube) biofilm inhibition experiments.

FIG. 17A is a schematic showing light generated from a LED entering into a SEOF at multiple angles relative to the axial orientation of the fiber and how SEOF surface roughness increases side emission. FIG. 17B is a bar graph comparing the total side emitted power from modeled 500 μm diameter, 30 cm long silica optical fibers with a 15 μm thick CyTop™ coating. The total power from fibers with a flat CyTop™ surface, a wavy CyTop™ surface, and an average of 60 differently random rough each ran 3 times, are shown. The error bars represent the 99% confidence interval of the average of 60 trials.

FIG. 18 shows surface roughness of 500 mm optical fiber with varying density (time) of perfluorotributylamine treatment.

FIG. 19A shows the influence of subtractive engineering on increasing side emission of light (μW/cm²). FIG. 19B shows cumulative side-emitted power (mW) from a 30 cm SEOF with varying SR from control (0.3 μm) to 0.65 μm. Error bars represent triplicate measurements using three different SEOFs.

FIG. 20 shows the experimental UV-C intensity response of Pseudomonas aeruginosa biofilm with lower (<10⁴ CFU/mL) or higher (>105 CFU/mL) feedwater recirculation. Each point is an individual replicate.

### DETAILED DESCRIPTION

Biofilms in pressurized water systems pose both operational challenges (e.g., membrane fouling, clogging of valves, fouling of sensor surfaces, unaesthetic particulates in drinking water) and potential health risks from opportunistic pathogens that reside within biofilms (e.g., Nonluberculous Mycobacleria, Legionella pneumophila or Pseudomonas aeruginosa). Coupling UV-C LEDs to side emitting optical fibers (SEOFs) as described herein allow delivery of light to large surface areas in narrow or curved channels.

This disclosure describes the use of <550 μm diameter flexible side-emitting optical fibers (SEOFs) that emit UV-C light along their entire length. SEOFs are designed to fit into narrow diameter tubing and inhibit biofilm growth from forming on the tubing walls. Factors influencing the tunability of irradiance from SEOFs are disclosed. To enable flexibility and strength, UV-C transparent polymers are coated on the surfaces of glass optical fibers, allowing side emission of UV-C light. By modulating the surface roughness of the polymers using a scalable subtractive engineering approach, the extent of side-emitted UV-C light can be controlled, ranging from <5 μW/cm² to over 50 μW/cm² perpendicular to the flexible fibers. Implementations described herein can be implemented in the absence of nanoparticles in the optical fiber coating.

The effectiveness of UV-C SEOFs in controlling biofilms produced by Pseudomonas aeruginosa was evaluated inside flexible tubing with a recirculating nutrient rich and planktonic bacteria solution. Without SEOFs, biofilms grew inside on tubing surfaces. SEOFs with an intermediate polymer surface roughness achieved a >2-log reduction in biofilm (<100 CFU/cm²) on the interior surface of the tubing. This approach provides tunability in side-emitted UV-C light and offers a scalable manufacturing strategy for inhibiting biofilms on complex wetted surfaces.

This disclosure also describes side-emitting optical fibers (SEOFs) formed into spacers for use in reverse osmosis (RO) water filters to mitigate biofouling on RO membranes. RO membrane spacers are positioned between layers of RO membranes in spirally wound filters to provide mechanical support and promote fluid turbulence. This disclosure describes forming one or more SEOFs coated with one or more UV-C transparent polymers into a spacer that is patterned to permit a through-flow of water. The SEOF spacer can then be spirally wound in direct contact with the RO membrane to provide gaps between the layers of the RO membranes. The SEOFs of the spacer can be optically coupled on the exterior of the filter to a light-emitting diode (LED). The SEOFs provide UV-C light from the LED to the RO membrane surface to mitigate biofouling (e.g., the growth of biofilms).

Through ray-tracing models and physical experiments, it was established that increasing the surface roughness of SEOFs enhances the side emission of UV-C light from glass fibers coated with UV-C transparent polymers. The results showed a remarkable increase of over 10 times in the side emission of 275 nm light when employing a subtractive engineering approach to modify the outer polymer surface roughness.

By carefully controlling the surface roughness, a balance was achieved between maintaining the physical flexibility of the SEOFs and maximizing UV-C light emission. Lower- and medium-surface roughness levels (<0.4 μm and <0.5 μm, respectively) exhibited a significant boost in UV-C light emission while preserving flexibility of the SEOF. The same fibers side-emit across multiple UV wavelengths.

The subtractive engineering approach allows tunability in reducing biofilm density on wetted surfaces within small diameter tubing, representative of point-of-use applications. It was observed that delivering an irradiance level on wetted surfaces equivalent to an irradiance measurement exceeding 4.5 μW/cm² measured in air effectively reduced biofilm formation on the tubing walls.

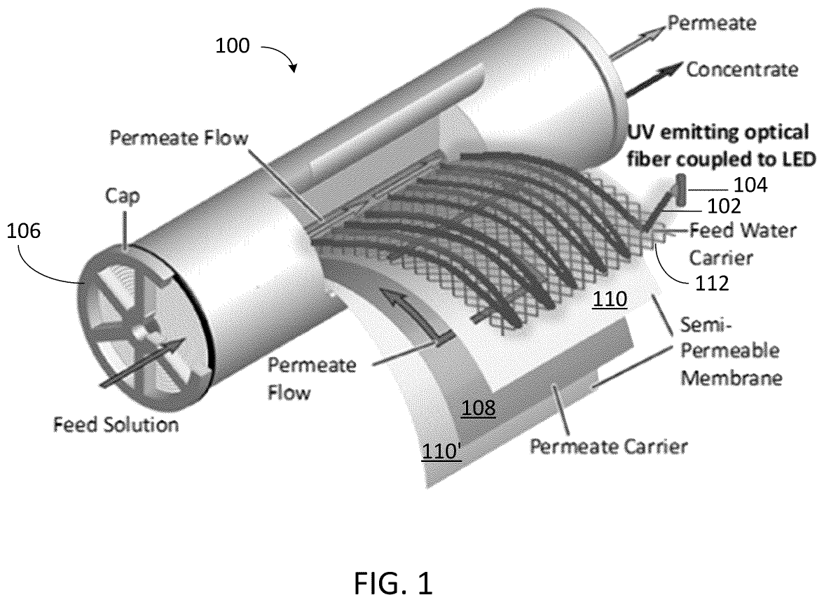

FIG. 1 depicts a partially exploded view of an embodiment of a spiral wound reverse osmosis (RO) membrane filter module 100 that includes SEOF(s) 102. SEOF(s) 102 are arranged in a zig-zag configuration and optically coupled to UV-C LED 104. Feed solution flows through cap 106 at a first end of module 100. Permeate carrier 108 is positioned between semi-permeable RO membranes 110 and 110′. SEOF(s) 102 contact spacer 112. In some embodiments, SEOF(s) 102 are arranged as a mesh, lattice, matrix, or network and can be used as a spacer 112. Permeate and concentrate exit through a second end of module 100.

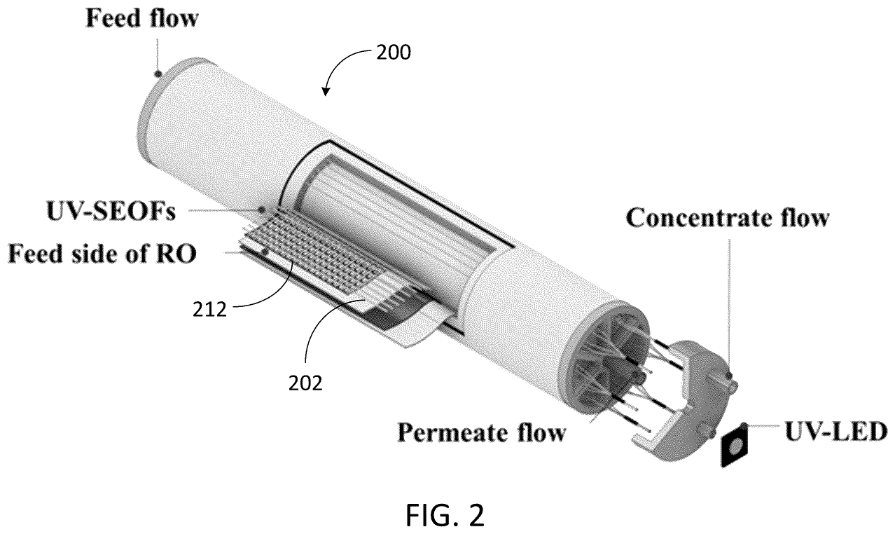

FIG. 2 depicts a second embodiment of a spiral wound RO membrane filter module 200 with flexible SEOF(s) 202 arranged along a length of module 200 within the spiral-wound RO membrane module.

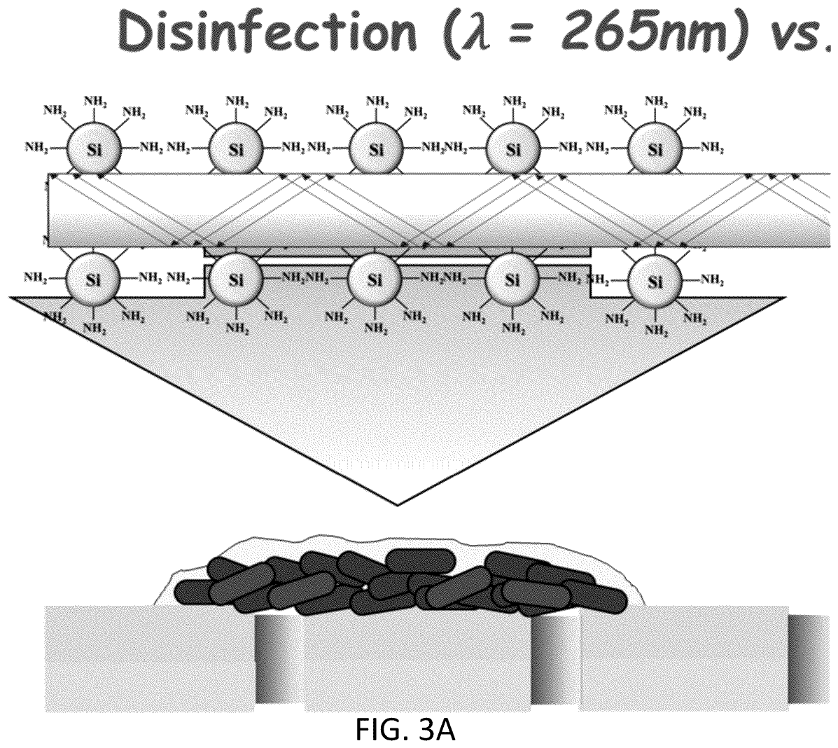

FIGS. 3A and 3B depict SEOFs coated with silica nanoparticles and titania nanoparticles, respectively, and mitigation of biofouling on the surface of an RO membrane. The optical fiber has been stripped of its cladding, which is the coating that maintains total internal reflection, and has been optically coupled to an UV LED source. In FIG. 3B, the SEOF is coated with titanium oxide nanoparticles which, when exposed to UV-A radiation (e.g., 365 mm), generate hydroxyl radicals that can interact with the biofilm coating the reverse osmosis (RO) membrane. The hydroxyl radicals are non-selective and can oxidize whole cell constituents. In FIG. 3A, the SEOF is coated with a UV-C transparent coating including silica nanoparticles that facilitate the side-emission of the radiation. The UV-C radiation (e.g., 265 nm) can inhibit biofouling by cleaving the RNA/DNA of the bacteria forming the biofilm and thus hindering its growth or proliferation on the membrane surface. In some implementations, the SEOF is coated with a UV-C transparent polymer and is free of nanoparticles (e.g., free of silica and titania nanoparticles). As described herein, a “UV-C transparent” coating typically allows transmission of at least 90%, at least 95%, or at least 99% of incident UV-C light. Examples of suitable UV-C transparent coatings include fluoropolymers (e.g., amorphous fluoropolymers).

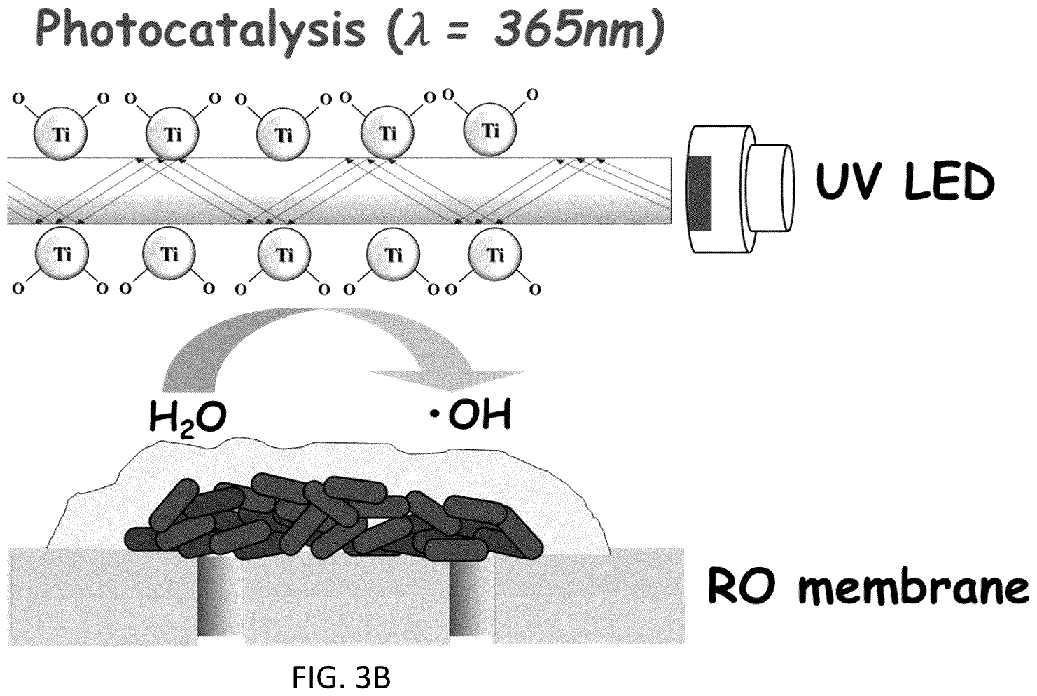

FIG. 4 depicts a pattern suitable for RO spacer 400, where the pattern would be formed with SEOF(s) 402 with openings 404 between SEOF(s) 402. Openings 404 can have a geometrical shape (e.g., a rectangle or a parallelogram). A linear dimension of each opening can exceed a diameter of SEOF(s) 402. RO spacer 400 can be in the form of a sheet with a thickness in a range of about 0.5 mm to about 1.5 mm. RO spacer 400 can include a woven or non-woven fabric of SEOF(s) 402. SEOF(s) 402 suitable for fabricating RO spacer 400 can have a diameter in a range of about 100 μm to about 1000 μm and a length in a range of about 20 cm to about 1 km. Other embodiments include changing the pattern design and weaving the SEOFs to make a more open or tighter mesh design.

### EXAMPLES

### Example 1

Optical fiber lacking the cladding that causes total internal reflection can be made in kilometer lengths. The fiber is loaded with silica nanoparticles under controlled and sequential treatments. The silica-loaded optical fiber is then coated with a UV-C transparent polymer coating (CyTop™). This coating prevents the release of the silica particles and provides flexibility. Wavelengths of LEDs lights including 265, 275, 285, 300, and 365 nm have been tested for biofouling control with SEOFs.

As the UV-C LED light source launches the light into the SEOFs, the light wave travels along with the entire fiber to the SEOF mesh, and the UV-C light is scattered on the side of the optical fiber mesh to provide disinfection to membranes. The CyTop™ polymer coating on the SEOF provides flexibility and facilitates making a flexible spacer for use in spirally wound RO membranes.

Multimode optical fibers were purchased from Thorlabs (diameter: 1 mm, numerical aperture: 0.39, core refractive index (RI), 1.5; high-OH: 300-1200 nm, FT1000UMT, Thorlabs, Newton, NJ, USA). Aminated silica sphere nanoparticles (NPs) suspended in 99.99% ethanol were obtained from NanoComposix (San Diego, CA, USA). CyTop™ was used as a low UV-C absorbing polymer (CyTop™, BELLEX International Corp, Wilmington, DE, USA).

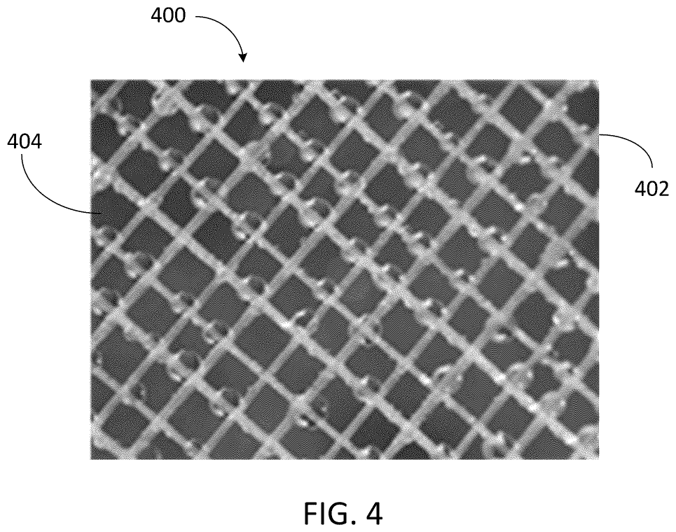

The fabrication steps of the UV-C and UV-A SEOFs for disinfection and photocatalytic oxidation are depicted in FIG. 5. Fiber optic segments 9 cm long were cut with a ceramic blade to obtain a smooth and flat cut surface. The polymer cladding on the Thor fiber optics was manually removed using a specialized microstripper. The stripped fibers were then soaked in acetone for 15 min to dissolve the polymeric cladding, which is a thin coating that maintains the total internal light reflection. The uncoated fibers were subsequently rinsed and cleaned with nanopure water. The optical fiber segments were individually fixed to metallic LED connectors (SMO5SMA, Thorlabs) using the heat-shrink wrap. The fibers were mounted on a fiber support (D50SMA, Thorlabs), and the cut surface was polished with optical polishing paper (LF30P, LF5P, and LF03P) until a specular surface was obtained. Both tips of each optical fiber were polished, and the uniformity of the polished fiber tips was evaluated. These fibers were then coated to enable UV-C light side emission or UV-A enabled photocatalysis.

For UV-C SEOF, 200 nm aminated silica sphere NPs (suspended in 99.99% ethanol, 10 mg mL⁻¹; NanoComposix, San Diego, CA) were used as scattering centers. The aminated silica NPs were coated onto stripped optical fibers through electrostatic attraction using dip-coating for 60 s, followed by air drying for 5 min. A low-UV-C absorbing polymer (CyTop™, BELLEX International Corp, Wilmington, DE, USA) treated the bare or NP-coated optical fibers. The fibers were then dipped in the polymer solution and dried in air for 2 h. The CyTop™ has negligible attenuation, light scattering, and reflection effects.

For UV-A SEOF, the TiO₂ P90 photocatalyst (Sigma Aldrich) was deposited on the fiber surface using a dip-coating method. A 1.0% TiO₂ P90 dispersion (10 g L⁻¹) was prepared. The dispersion solution was prepared in nanopure water and sonicated using a QSonica Misonix immersion sonicator for 15 min. The optical fibers were immersed in the dispersion solution for 60 s and then slowly removed from the dispersion solution. Subsequently, the coated fibers were heat-dried at 100° C. for 5 min to ensure their adhesion to the optical fiber surface.

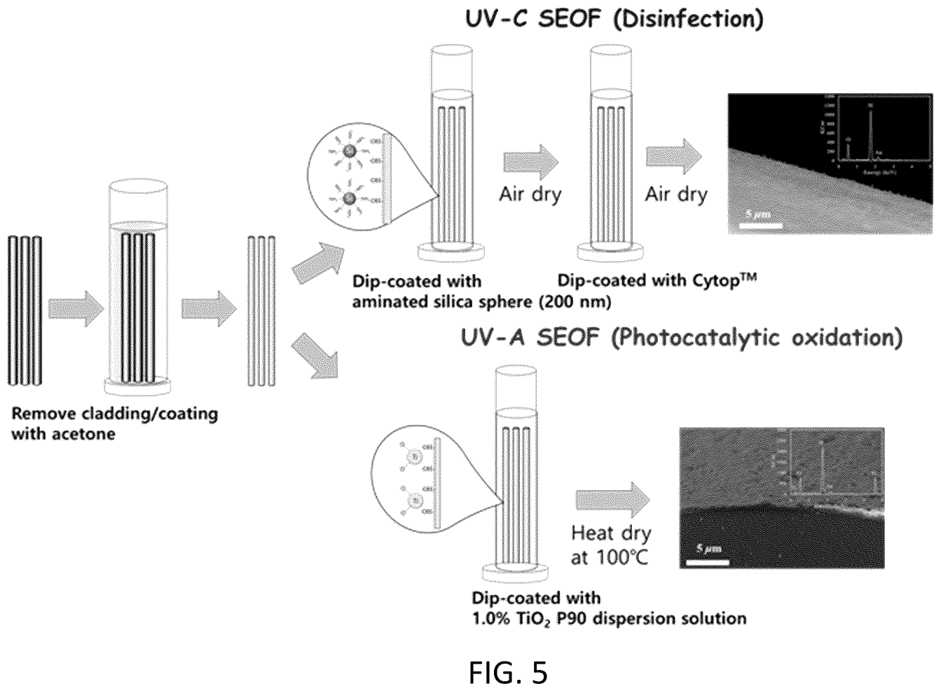

FIGS. 6A and 6B show a RO membrane test apparatus equipped with two SEOFs. FIG. 6A is a schematic of the membrane cell that is fully-enclosed and allows cross-flow of water through the chamber, which is equipped with an optical quartz window to enable in-situ optical coherence tomography (OCT) measurements of biofilm density on the membrane surface. The SEOFs glow (i.e., side-emitting light) when connected to a functioning LED, which is located outside the membrane cell. SEOFs are located less than 1 mm from the RO membrane surface. FIG. 6B shows the membrane cell configured within a temperature-controlled recirculating system. Prior to all tests, the chemical coatings on the active layer of the RO membrane coupons were completely removed by soaking overnight in deionized (DI) water. During all tests, separate parallel membrane cells were operated but used a common feed tank such that both the control (SEOF without LED illumination) and treated (SEOF with LED illumination) received the same bacterial concentrations over the duration of the experiment (basis for 8 days of continuous recirculation).

The membrane cell included three primary components. First, membrane coupons with dimensions of 50 cm² were cut from a commercial brackish water reverse osmosis (BWRO) membrane element (MPD-based thin-film composite PA; Applied Membrane Inc., M-T1812A24). Second, SEOFs were fabricated and placed within a 1 mm thick spacer (FIG. 6B) and connected, outside the cell, to different types of LEDs. Third, UV-LEDs (UV-C: 60 mW, Crystal IS, NY; UV-A: 1 W, NVSU233B, Nichia Corporation, Japan) at 265 nm and 365 nm were used for UV-C and UV-A SEOFs, respectively. The same electric current (0.45 Amp) was applied to LEDs with different wavelengths.

The biofouling propensity and salt rejection of RO membrane systems were separately evaluated using a lab-scale cross-flow RO unit at a cross-flow velocity of 0.35 cm·s⁻¹ using 10 L of synthetic wastewater as feed water under recirculation mode with 5 bar pressure for 8 days. Table 1 shows the characteristics of the feed water (i.e., synthetic wastewater) which has an ionic strength of 15.9 mM and 40 mg L⁻¹ of organic carbon substrate (glucose); analytical grade NaCl, MgSO₄·7H₂O, NaHCO₃, CaCl₂·2H₂O, KH₂PO₄, NH₄Cl, and Na₃C₆H₅O₇·2H₂O were purchased from Sigma-Aldrich (St. Louis, MO, USA). The initial inoculum of bacteria was 5×10⁸ CFU/mL using a culture of Pseudomonas aeruginosa (ATCC 15692).

TABLE 1
Feed water characteristics for biofouling experiments.

| Chemical | Concentration (mM) | Concentration |
|---|---|---|
| NaCl | 8 | 468 |
| MgSO₄•7H₂O | 0.15 | 37 |
| NaHCO₃ | 0.5 | 42 |
| CaCl₂•2H₂O | 0.2 | 29 |
| KH₂PO₄ | 0.2 | 35 |
| NH₄Cl | 0.4 | 21 |
| Na₃C₆H₅O₇•2H₂O | 0.6 | 83 |
| Total | 10.05 | 808 |
| | (Ionic strength: 15.9) | |
| Glucose | | 40 |

Deionized (DI) water was added to the membrane coupon for 2 h before applying feed water to ensure membrane compaction. Continuous flux rates were measured gravimetrically using a scale (MS3002S/03, Mettler-Toledo, OH, USA), and real-time fouling layer formation was monitored by optical coherence tomography (OCT; Thorlabs, Germany) using the Fourier-domain scanning technique at a relatively high scanning rate (30 kHz). To calculate salt rejection, the concentrations of ions in the feed and permeate were measured using a conductance meter (Orion Versa Star Pro Advanced Electrochemistry Meter, Thermo, WA). Permeate water flux (J_{w}), and rejection (%) were calculated as:

$$Permeate flux ( {J}_{w} , L {m}^{- 2} {h}^{- 1} ) = \frac{V}{A} \qquad ( 1 )$$

$$Rejection ( \% ) = ( 1 - \frac{{C}_{p}}{{C}_{f}} ) \times 100 \qquad ( 2 )$$

where V is the permeate flow (L·h⁻¹), A is the membrane surface area (m²), and C_{f} and Cₚ are the salt concentrations in the feed and permeate, respectively. The fouled RO membranes were collected after 8 d of cross-flow experiments and further analyzed using various techniques.

To confirm side-emission, the light intensity (265 nm and 365 nm) along the SEOF surfaces were analyzed using a spectrophoto-radiometer (calibration: 200-1100 nm; Avantes, Louisville, CO, AvaSpec-2048 L) at different lengths along the fiber (L=1, 2, 3, 4, 5, 6, 7, 8, and 9 cm). To confirm production of hydroxyl radical (⋅OH) generated from UV-A SEOFs, experiments were performed using a solution para-hydroxybenzoic acid (p-HBA) from 1 μM benzoic acid. Because the benzoic acid reacts with ⋅OH to form three hydroxybenzoic acid isomers, ortho, meta and para hydroxybenzoic acid, in a ratio of 1.7:2.3:1.2, the production of hydroxyl radical can be confirmed by quantifications of p-HBA.

Membrane surface properties, zeta potential and contact angle (i.e., hydrophobicity) of the virgin and fouled RO membranes were determined using the streaming potential measurements (MCR 102, Anton Paar GmbH, Graz, Austria) in a 10 mM KCl electrolyte solution and a goniometer (Attension Theta by Biolin Scientific, Gothenburg, Sweden), respectively.

At the end of each membrane test, the biofilms were characterized. Bacterial deposition on the fouled RO membranes was quantified using a colony-forming unit (CFU) assay. To extract bacterial deposition on the fouled membrane, the fouled membranes were gently washed in synthetic wastewater, placed in 15 mL Falcon tubes filled with 5 mL of synthetic wastewater, and bath sonicated for 6 min to remove cells without compromising viability. A 0.1 mL volume of the solution in the Falcon tube was withdrawn and diluted at 1:100. The 1:100 solution was placed in 50 mL aliquots, placed in an incubator, and allowed to grow overnight. CFU counts were determined the following day. Live/dead cell viability was determined using a Leica DM6 fluorescence microscope (Leica Microsystems Inc. Buffalo Grove, IL) after the injection of 3 mL of 3.34 mM Syto9 and 3 mL of 4.67 mM propidium iodide (Molecular Probes, Carlsbad, CA) into each flow channel to stain live and dead cells in green and red, respectively. Images were analyzed using ImageJ software (National Institutes of Health, MD, USA) to determine live cell viability. The phenol-sulfuric acid method and a Micro BCA™ Protein Assay Kit (Thermo Scientific, Waltham, MA, USA) was used to determine extracellular polymeric substance (EPS) concentrations (e.g., polysaccharides and proteins) from the supernatants based on the calibration curves between concentrations and UV absorbances. To quantify the gene expression of bacterial deposition on the fouled membranes involved in quorum sensing (QS; i.e., IasI/R and rhII/R), polysaccharide synthesis (i.e., pelA and pslA), surface attachment (i.e., cdrA and sagS), and oxidative stress response (i.e., msrB, sodM, and ospR), real-time quantitative PCR (RT-qPCR) was performed in 15 μL of reaction mixture composed of 2 ng of cDNA, SYBR Green Master Mix (7.5 μL), each primer at 0.3 μM, and water, using the housekeeping gene recA as an internal standard.

Either aminated silica or TiO₂ were homogeneously distributed on the surfaces of the UV-C and UV-A SEOFs, respectively, based upon scanning electron microscopy images. X-ray diffraction (XRD) spectra of TiO₂ (P90) powder alone, the pristine optical fiber and UV-A SEOFs confirmed the presence of TiO₂ on the coated fiber, and that anatase is the dominant phase; anatase is photocatalytic when exposed to 365 nm light.

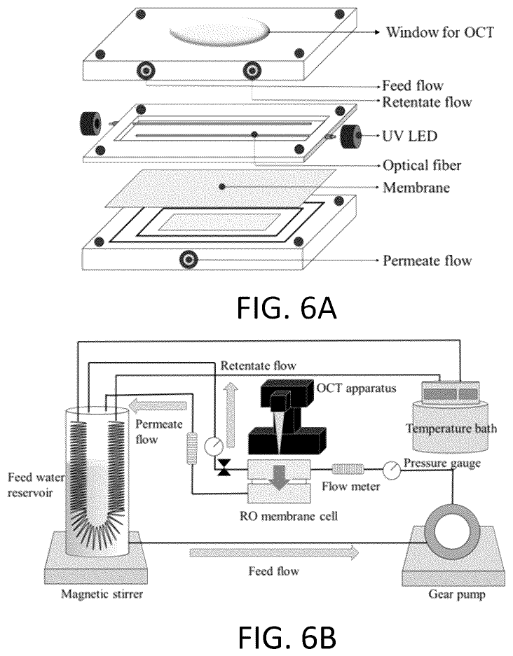

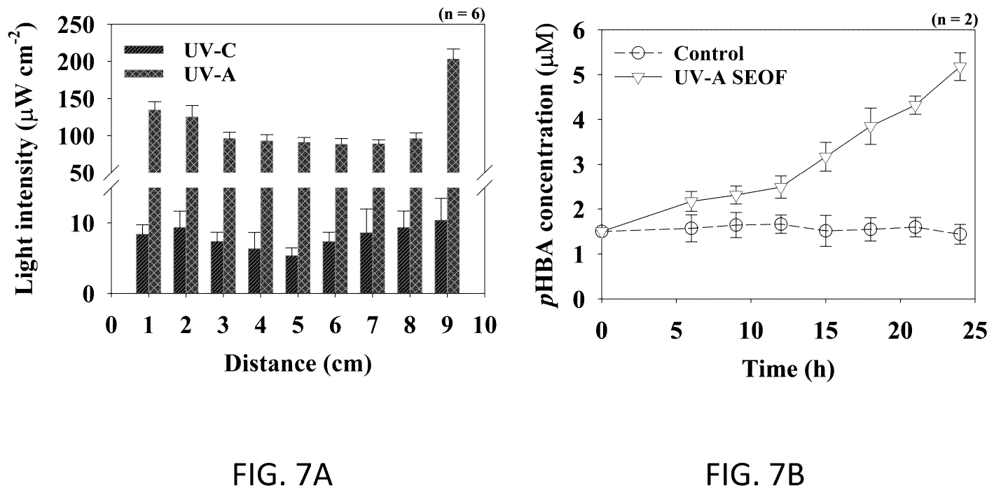

Over the length of the SEOF, light was uniformly side-emitted from the optical fibers. FIGS. 7A and 7B show side-emitted light fluence. Despite applying the same current (0.45 Amp) to both 265 nm and 365 nm LEDs, the side scattered light for the UV-A enabled SEOF averaged 100 μW·cm⁻² (89-200 μW·cm⁻²) and was higher than the 10 μW·cm⁻² average (6-10 μW·cm⁻²) from the UV-C enabled SEOF, respectively. This is because in addition to using a higher wattage LED the longer wavelength LEDs are more efficient at producing light rather than heat. Light fluence was slightly higher at the proximal end because it was near the LED, and at the proximal end because of back-refracted light still being transmitted within the SEOF. Thus, the nanoparticle coatings were effective at delivering light to the surface of the SEOFs.

For the 365 nm LED and TiO₂ coated SEOF, the photocatalytic behavior was demonstrated by oxidation by ⋅OH of benzoic acid (BA) to p-HBA. FIG. 7B shows no p-HBA for a non-coated optical fiber attached to the UV-A LED, whereas p-HBA formation increased gradually over time for the TiO₂ coated SEOF. This validated the potential for the TiO₂ coated SEOF to produce ⋅OH.

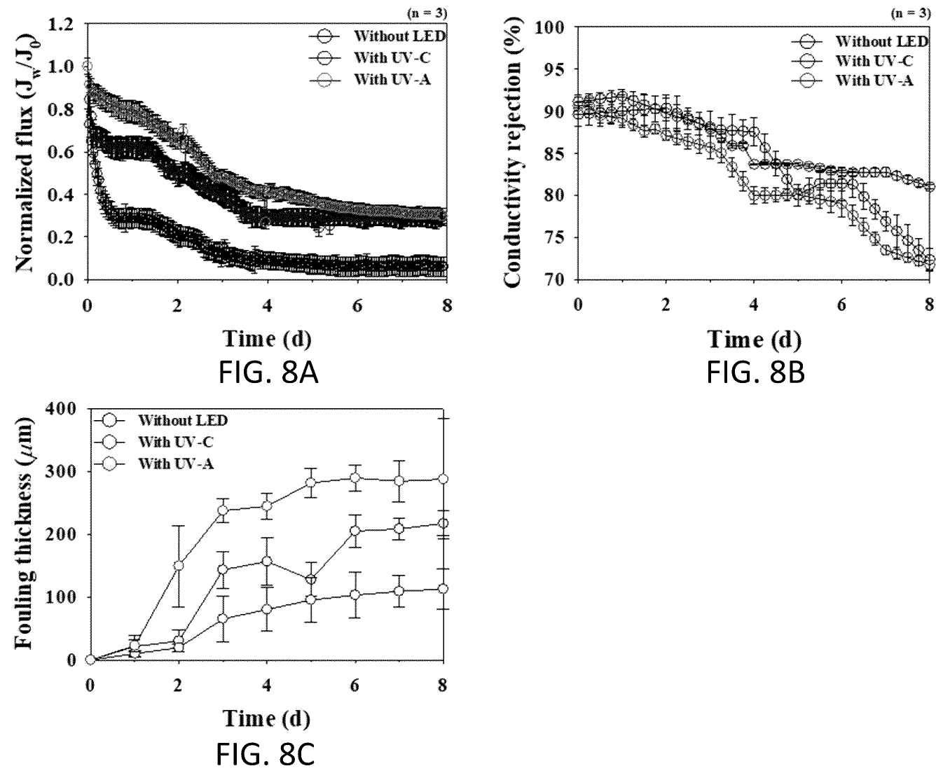

FIGS. 8A and 8B show water flux and salt rejection during control and UV irradiated experiments over an eight day period with a recirculating feed solution containing P. aeruginosa. The control experiment had SEOFs in the membrane cell, but there was no LED attached (i.e., no irradiation on SEOFs and thus only hydrodynamic influences). The aim was to test surface mitigation of biofouling, and, by using a common large volume of recirculating feed water containing bacteria for both control and UV irradiated membrane cells, any inactivation or stress to planktonic bacteria would be experienced by both parallel membrane cells. Planktonic bacteria were expected to be continuously deposited onto the membrane surfaces, even in the presence of UV irradiation from the SEOFs. Control and UV irradiated experiments each had the same initial permeate flux (11.5 L·m⁻² h⁻¹).

FIG. 8A shows the normalized permeate flux of the RO unit equipped with the SEOFs decreased over time, indicating that some biofouling likely occurred on the RO membrane surfaces. Control experiments showed the fastest and largest extent of flux decline. Permeate flux decline was slower when SEOFs were irradiated with light from the LEDs. The results were highly reproducible, as evident by small error bars on flux decline tests from duplicate experiments. The UV-C irradiated SEOF exhibited a faster initial flux decline, compared against the UV-A irradiated SEOF experiment, but then a slower rate of flux decline over the remaining 8 days. This suggests a steady-state formation of a biofilm on the surface. A continuous flux decline over time was observed with the UV-A irradiated SEOF. After 8 days both the UV-A and UV-C irradiate SEOF experiments had similar flux declines (J_{w}/J₀˜0.4) that indicated less biofouling than the control (J_{w}/J₀<0.1). Because planktonic bacteria were present in the recirculating nutrient-rich feed solution, it was not expected that the surface would be sterilized with the SEOFs but only that less permeate flux decline would be achieved, associated with somewhat constant attachment/detachment of bacteria from the membrane surface. This trend appeared to be attained, based upon permeate fluxes, for the UV-C irradiated SEOF.

FIG. 8B shows changes in salt rejection over time for control and UV irradiated SEOF experiments. Similar losses in salt rejection were observed over the first few days, after which the UV-C enabled SEOF maintained higher salt rejection than the control or UV-A irradiated SEOF. Possible reasons to explain the decreased salt rejection include: i) ROS generated by UV-A SEOFs can pass through the biofouling layer, damage the membrane surface, and thereby leading to detrimental effects on the performance of membrane; and ii) the surface charge of the RO membrane can be reduced by bacterial deposition on the RO membrane surface, leading to decreased Donnan exclusion effects. The loss in salt rejection was greatest for the UV-A SEOFs, slightly more so than even the membrane cell that wasn't irradiated with any UV light. Moreover, the highest permeate water production was observed in UV-A SEOFs when compared to UV-C SEOFs and control experiments.

The biofouling layers were monitored in real-time by OCT during the RO membrane operation and the thickness of the biofilm layer was estimated from the OCT images. FIG. 8C shows changes over the duration of each experiment. It was expected that UV irradiation would decrease the thickness of biofilms on the RO membrane surface. Unexpectedly, the biofilm layer after 8 days was thicker on the membrane with the UV-A photocatalytic SEOFs (287±95.7 μm) compared against the control system without UV irradiation (217±19.6 μm). However, the thinnest biofilm layer was observed in the membrane cells equipped with UV-C SEOFs (103±31.7 μm). Furthermore, 3-dimensional OCT images of the RO membrane surface after 8 days show a relatively loose, low density, rough biofilm layer for the UV-A SEOFs, compared to a more compact biofilm layer on the control or UV-C SEOF membrane cells.

Biofouling was influenced by the photocatalytic oxidation or disinfection from UV-A and UV-C SEOFs. UV-A SEOFs promoted the formation of a less dense but thicker biofouling layer, and the generated ROS from UV-A SEOFs may pass through the less-dense biofouling layer, affecting degradation of polymeric RO membrane surface. UV-C irradiated SEOFs had less loss of permeate flux (i.e., less biofouling) than the control and retained the highest rejection of salts. UV-C irradiated SEOFs also achieved the most consistent performance (i.e., least change in permeate flux or salt rejection over 8 days), which corresponds logically to the membrane cell with the least influence from biofilms (i.e., thinnest biofilm layer—FIG. 8C).

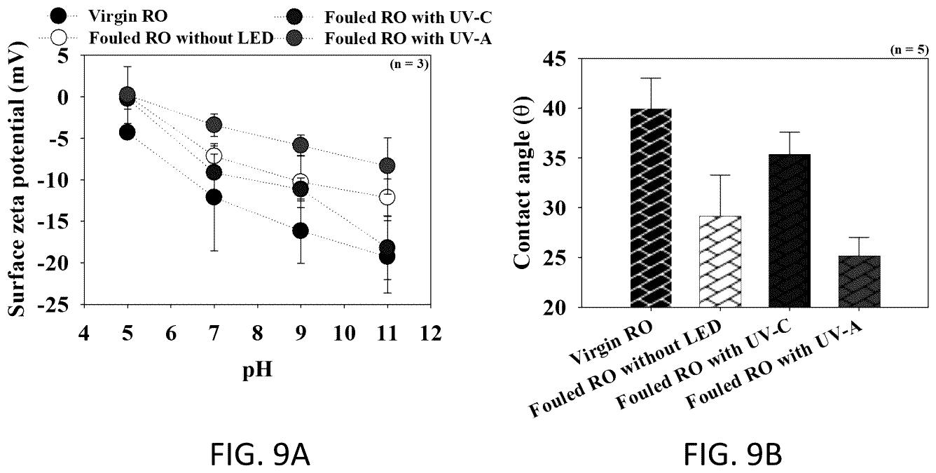

Surface characterization of membranes provide additional insights into the nature of foulants attached to the membranes. FIG. 9A shows zeta potential of virgin and fouled membranes (from control or UV SEOF experiments). The virgin and fouled RO membranes show negatively charged zeta potentials over most of the pH range. The amphoteric curves are associated with the carboxyl and amine functional groups attached to the RO membranes. Furthermore, the surface zeta potential values of the RO membrane became less negatively charged, as the biofouling layer formed on the membranes in the order of UV-A>without LED>UV-C(without LED at pH 7: −12.1±6.5 mV, UV-C at pH 7: −9.1±2.2 mV, UV-A at pH 7: −3.4±1.3 mV). This likely indicates larger accumulation of biofoulants on RO membrane equipped with UV-A SEOFs than the control without UV irradiation. The ⋅OH generated by UV-A SEOFs may be promoting accumulation of biofoulants near the membrane surface.

Surface contact angles of the virgin and fouled RO membrane surfaces are shown in FIG. 9B. Virgin RO membrane shows the highest contact angles (40±3°). In the control tests, biofouling rendered RO membrane surface more hydrophilic (i.e., 29±4°). UV-C irradiated SEOFs resulted in a surface contact angle (35±2°) closer to the virgin membrane (40±3°) than the control membrane system (29±4°). UV-A irradiated SEOFs resulted in a surface with the lowest contact angle (25.2±1.9°). Overall, changes in surface contact angle followed the same trend as biofilm thickness (FIG. 8C), with thicker biofilms showing larger differences.

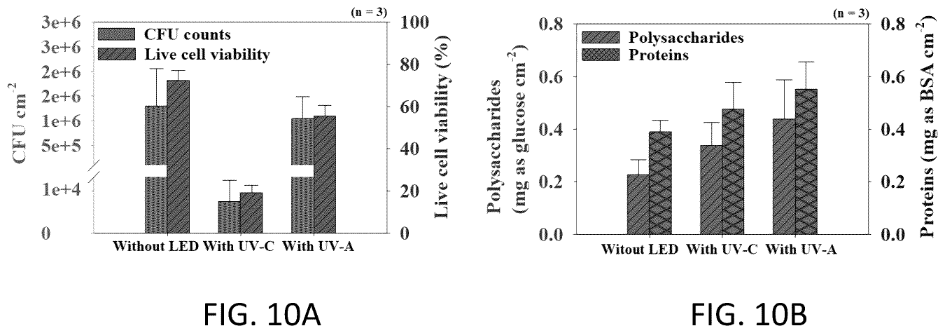

To support in-situ OCT measurements of biofilm density over time, after 8 days of testing the membrane cell was opened and biomass collected from nine regions distributed across the membrane surface. Surface contour plots for various measurements were made by assigning a measured concentration to each of these nine regions on the membrane surface (i.e., length and width plotted on x- and y-axes). Averaged across all nine regions as shown in shown in FIGS. 10A and 10B, bacterial counts averaged 1.6×10⁶, 0.8×10⁴ and 1.3×10⁶ CFU·cm⁻² for the control, UV-C and UV-A SEOF experiments, respectively. Bacterial counts were not uniform across the membrane surface, but showed less than 1 log difference in CFU/mL across the membrane. Consistent with OCT measurements, UV-C irradiated SEOF experiments showed the lowest biofilm accumulation with a maximum CFU/mL of ˜2×10⁴/mL which is ˜2 log lower than maximum bacterial counts for the control or UV-A irradiated SEOF systems (˜2.5×10⁶/mL).

Based upon staining and confocal images obtained from the fluorescence microscope measurements, FIGS. 10A and 10B show that UV-C irradiated SEOF experiments exhibited the lowest live-cell viability (18%), followed by 60% viability for UV-A irradiated SEOFs and 71% viability in control experiments. These results are consistent with CFU/mL data, showing the largest impact by UV-C irradiated SEOFs.

In parallel with locations for bacteria concentrations (CFU/mL) for the control, UV-C and UV-A SEOF experiments were conducted for EPS components (polysaccharides and proteins, respectively). EPS levels were lowest for the control and highest for the UV-A irradiated SEOFs, with UV-C irradiated SEOFs having intermediate levels. Polysaccharide and protein concentrations are of similar orders of magnitude (0.1 to 1 mg·cm⁻²) and exhibit similar spatial patterns across the membrane surface. Data suggest different spatial patterns in biofilm growth for the control versus UV-irradiated experiments.

Control experiments appear to have highest biofilm density around the outside walls of the membrane cell, whereas the UV irradiated SEOFs have the highest density in the center of the membrane cell. Control experiments had SEOFs without irradiation, so these patterns are unlikely associated with differences in hydrodynamics within the membrane cells. Instead, the difference in spatial patterns is believed to be associated with bacterial responses to UV-C light or UV-A photocatalytically produced ROS.

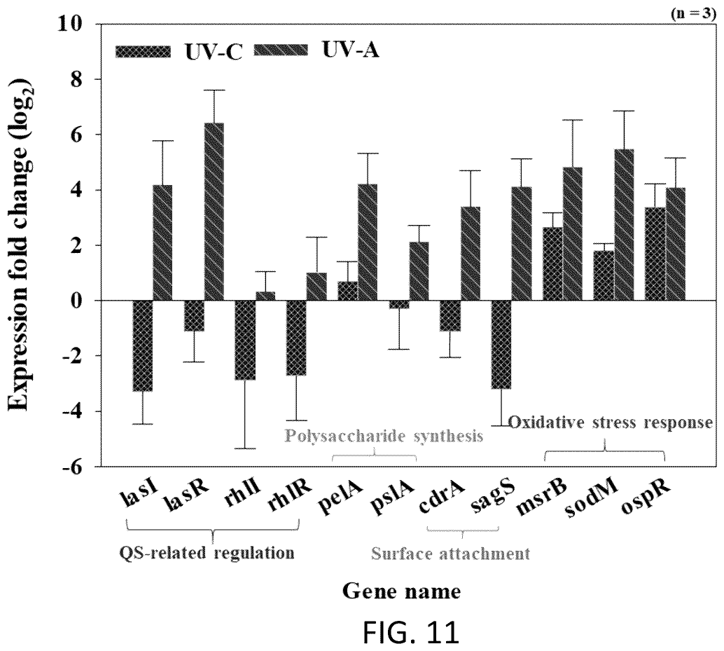

To investigate how bacteria are responding to UV-C irradiation or UV-A generated ⋅OH biofilm samples were subjected to transcriptomic analysis. Overall, both UV-C and UV-A SEOFs induced the expression of P. aeruginosa genes associated with biofouling formation on RO membranes. P. aeruginosa generally contains two quorum sensing (QS) systems, las and rhl, and either system consists of one transcriptional activator (lasR or rhlR) and an autoinducer synthase (lasI or rhlI). The las system dominates and controls the rhl system, whereas the two systems are linked. FIG. 11 shows up or down regulation of several genes relative to control experiments (no UV irradiation). UV-C SEOFs induced lasI (4.2±1.6-fold), lasR (6.4≅1.2-fold), rhlI (0.3±0.7-fold), and rhlI(1.0±1.3-fold) respectively, while lasI(−3.3±1.2-fold), lasR (−1.1±1.1-fold), rhlI (−2.9±2.5-fold), and rhlR (−2.7±1.6-fold) were down-regulated by UV-C SEOFs, respectively. Separately, UV-A SEOFs upregulated expression of polysaccharides synthesis gene pelA (4.2±1.1-fold), and pslA (2.1±0.6-fold) and induced expression of surface attachment gene cdrA (3.4±1.3-fold), and sagS(4.1±1.0-fold), while both expressions of polysaccharides synthesis and surface attachment genes were down-regulated by UV-C SEOFs (pelA: 0.7±0.7-fold; pslA: −0.3±1.6-fold; cdrA: −1.1±0.9-fold; sagS: −3.2±1.3-fold).

Both UV-C and UV-A SEOFs induced expression of oxidative stress response. For UV-C SEOFs the responses were as follows: msrB=2.7±0.5-fold; sodM=1.8±0.3-fold; ospR=3.4±0.8-fold. For UV-A SEOFs the responses were as follows: msrB=4.8±1.7-fold; sodM=5.5 f 1.4-fold; ospR=4.1±1.1-fold). The photocatalytic UV-A SEOFs had significantly higher effects on the oxidative stress response.

Stimulation of quorum sensing, polysaccharide synthesis, surface attachment, and oxidative stress response corroborates the observation that a low level of ⋅OH generation by the UV-A irradiated SEOFs may hormetically promote biofilm formation, secretion of higher amounts of EPSs to protect microorganism growth, and resistance to oxidative stress. Perhaps higher levels of ⋅OH generation could be more effective for microbial inactivations. However, UV-C SEOFs that directly deliver germicidal irradiation (2 to 10 μW·cm⁻²) on the membrane surface are sufficient to effectively inhibit biofouling formation on the RO membrane, affecting the expression of quorum sensing regulation and surface attachment genes. This is because aromatic heterocyclic pyrimidine bases in DNA are dominant absorbers of UV light, while ROS generated by photocatalysis are non-selective, oxidizing whole cell constitutes. Overall, these results suggest superior performance of UV-C irradiated SEOFs to mitigate the detrimental effects of biofouling on membrane performance.

### Example 2

A 50-cm long biofilm reactor was fabricated with a SEOF capable of delivering UV-C irradiance ranging from 0 to ˜250 μW/cm² to a stainless-steel surface along the reactor length. Biofilm inhibition kinetics under UV-C light were monitored over time using optical coherence tomography (OCT) to calculate average biofilm thickness (mm) on surfaces. RNA from biofilm samples collected from three surface regions of variable UV-C irradiance (<5 μW/cm², >8 μW/cm², and >250 μW/cm² for 30 min irradiation) were reverse transcribed to DNA, which was sequenced to indicate which genes were differentially expressed in response to UV-C exposure. The selected genes were related to DNA repair, quorum sensing, mobility, and biofilm formation, which would inspire future studies of targeting biofilm inhibition strategy.

Pseudomonas aeruginosa (ATCC 15692, Manassas, Virginia) was used as model biofilm-forming bacteria for its ability to rapidly grow biofilms on surfaces and its pathogenic nature. An overnight culture was diluted 1:25 in LB broth and incubated at 37° C. until the optical density at 600 nm reached 1 cm⁻¹; this gave a bacterial suspension with a concentration of approximately 10⁹ CFU/mL. The suspension was diluted 1:1000 into M9 medium as feedwater for biofilm forming experiments. The M9 medium enables interference-free microscope imaging, which was suitable for OCT analysis in this work. At the beginning of each experiment, the feedwater was placed in a 5-L volumetric flask with an initial P. aeruginosa concentration of 10^{5.7±0.1} CFU/mL.

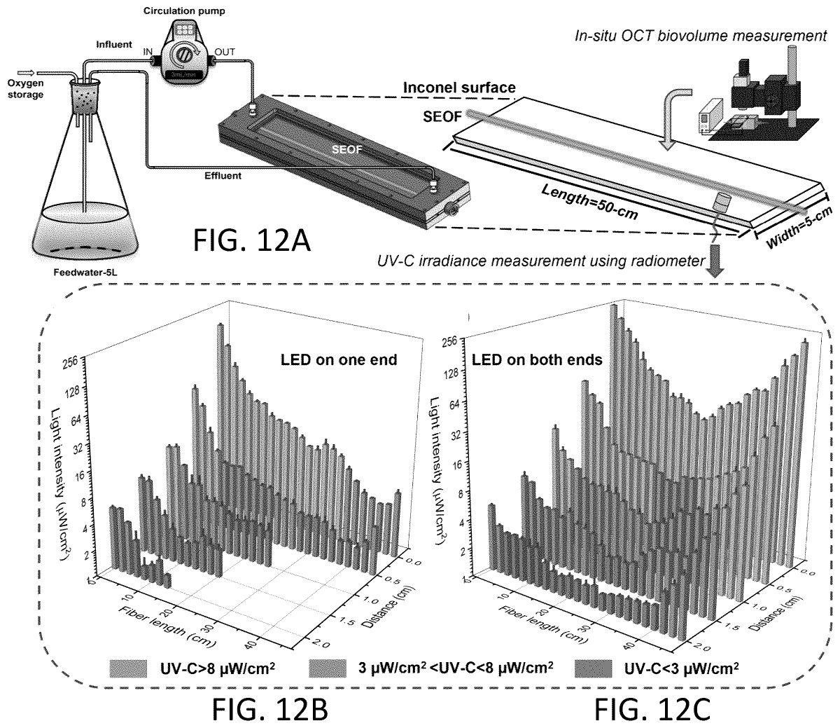

FIG. 12A shows the schematic of the reactor used to form biofilm and deliver UV-C via SEOFs. The 55-cm long biofilm reactor was watertight and had a light-transparent quartz window for in-situ imaging via OCT microscopy. A 50-cm×5-cm stainless steel (Inconel 625, HPALLOY, IN) metal plate was placed inside the reactor as the surface for biofilm formation.

A single 50-cm custom-made quartz SEOF was inserted on the top of the Inconel surface. A fixed spacing (˜0.3-cm) was intentionally maintained between SEOF to the Inconel surface and therefore any grown biofilms were perpendicular to the UV-C light side emitted from the SEOF. Fiber characteristics were 0.39 numerical aperture, 500-μm diameter, and 1.5 core refractive index (Polymicron, Phoenix, AZ). Fiber cut-ends were cleaned by an optical cleaner (Vytran, Thorlabs, NJ) to create a smooth surface for light transmission. SEOFs were connected to UV-C LEDs (80-mW) housed in a custom-designed integrated device (Pearl Lab FiberBeam™, Aquasense Technologies, Kentucky, USA) on both ends to create surface UV-C exposure. The UV-C emission from SEOFs was measured by a spectrophotoradiometer (AvaSpec461 2048L, Avantes, Louisville, CO). Light irradiance (μW/cm²) along the 50-cm optical fiber (L, cm) was measured at distances of 0, 0.5, 1.0, 1.5, and 2.0 cm perpendicular to the fiber surface (d, cm) and taken as the UV-C irradiance exposed onto the biofilm formed on the surface. The radiometer's detection limit was 1 μW/cm².

The feedwater containing P. aeruginosa was recirculated through the 55-cm reactor at 3 mL/min for 72 hours. The feedwater concentration during the recirculation ranged from 10^{5.7±0.1} to 10^{7.1±0.1} CFU/mL. Because the only UV-C irradiation in this experimental setup was from the fiber, planktonic bacteria in feedwater experienced low UV-C irradiation only when they were inside the reactor. Based upon the volumetric flowrate and residence time in the reactor, very low planktonic bacterial inactivation occurred in the flowing water. A dark control experiment was performed by using the same reactor design, including a SEOF, but without UV-C irradiation from LEDs; all other experimental conditions (i.e., surface, flow rate, time, feedwater) were maintained the same. Experiments with and without UV-C light were performed in triplicate.

In-situ biofilm formation on the surface during the recirculation period was measured every 24 hours using OCT focused through the quartz window. OCT images were analyzed using a 3D viewer and Voxel Counter Plugins with ImageJ. Biofilm average thickness (equals to volume of biomass (mm³) per unit surface (mm²)) at locations near the fiber surface (0 cm away from the SEOF) and 2 cm away from the SEOF were recorded every 4 cm along the 50-cm length.

A sterile brush was used to collect duplicated biofilm samples from four different zones in the 50-cm reactors, with or without side-emitting light. Two biofilm samples were collected after recirculating water for 72 hours in a reactor without SEOF irradiation. One sample was directly analyzed (i.e., dark control), and another sample was first subjected to 30-minute UV-C irradiation by a low-pressure UV lamp (ThermoFisher, Model #51032328, LPUV, 40V) that delivered 250 μW/cm² to the biofilm surface (i.e., Post UV-C exposed biofilm) before collection. The other two samples were collected from the reactor exposed to UV-C from the SEOF; the sample location zones were at different distances and corresponded to either 8-80 μW/cm² (i.e., effectively inhibited biofilms) or <3 μW/cm² (i.e., poorly inhibited biofilms).

Each sample prepared for RNA extraction was stored in RNAlater®(Thermo Fisher Scientific, US) solution at −20° C. A TRIzol™ Max™ Bacterial RNA Isolation Kit (Thermo Fisher Scientific, US) was used to extract the RNA from all biofilm samples. The extracted RNA was purified with a MICROBExpress™ Kit (Thermo Fisher Scientific, US) to remove ribosome RNA. Then, the mRNA was reverse transcribed to cDNA using a High-Capacity cDNA Reverse Transcription Kit (Applied Biosystems, US). All cDNA samples were shipped overnight in a cooler to CosmosID Inc. (MD, US) for shallow metagenomic sequencing.

After sequencing, the “Trimmomatic” tool was used to remove low-quality reads (sequence length<60 bp; quality score<30) from all cDNA sequencing reads. To investigate the transcriptional response of biofilms to UV-C exposure, the “UProC” toolbox was used to classify all samples' cDNA sequencing reads based on the KEGG (Kyoto Encyclopedia of Genes and Genomes) database. All cDNA reads were translated into amino acids sequences. Then, the obtained oligopeptides sequences (protein-level) were identified based on the “Mosaic Matching Score” best-matched protein family. The relative abundance of functional categories is presented as transcripts per million (TPM). The log₂fold changes of TPM of different samples represents response of genes in biofilms irradiated by UV-C light relative to response for the dark control biofilm sample.

All the experiments were performed independently in triplicate using three different SEOFs. For RNA sequencing, duplicate samples were collected separately. Student's t-test was used to determine statistical significance. Differences were considered as significant at the 95% confidence level (p<0.05).

UV-C light side-emitted along the length of a SEOF, transmitted into water and delivered onto the reactor surfaces, exponentially attenuates once the light leaves the fiber. Therefore, a UV-C “gradient” is generated axially along the length of SEOFs and perpendicular to the SEOF. FIG. 12B shows the light irradiance along the SEOF connected to the UV-C LED. At the fiber surface, the side emission (I_{SEOF}) varied from 156±8 μW/cm² at the proximal end (L=0 cm) to 4±1 μW/cm² at the terminal end (L=48 cm). Light irradiance was lower at distances farther away from the SEOF. For example, at the proximal end, UV-C irradiance decreased from 156±8 μW/cm² at d=0 cm to 5±0.4 μW/cm² at d=2-cm. Overall, UV-C irradiance inside the reactor with only one end of SEOF connected to the LED was highest at L=0 cm, d=0 cm and continuously decreased to zero at L=46 cm, d=2 cm.

FIG. 12C shows the light irradiance when LEDs were connected on both ends. A “U-shape” light distribution was created near the fiber surface; I_{SEOF} decreased from 246±9 μW/cm² at the proximal end (L=0 cm) to 24±1 μW/cm² in the middle (L=24 cm) and then continuously increased to 224±20 μW/cm² at the terminal end (L=46 cm). The light irradiances decayed at distances away from fiber surface following the same trend as that at d=0-cm for one-end illumination. Therefore, UV-C irradiance inside the reactor with LEDs on both ends maximized at L=0 cm, d=0 cm and at L=46 cm, d=0 cm, and it minimized at L=24 cm, d=2 cm.

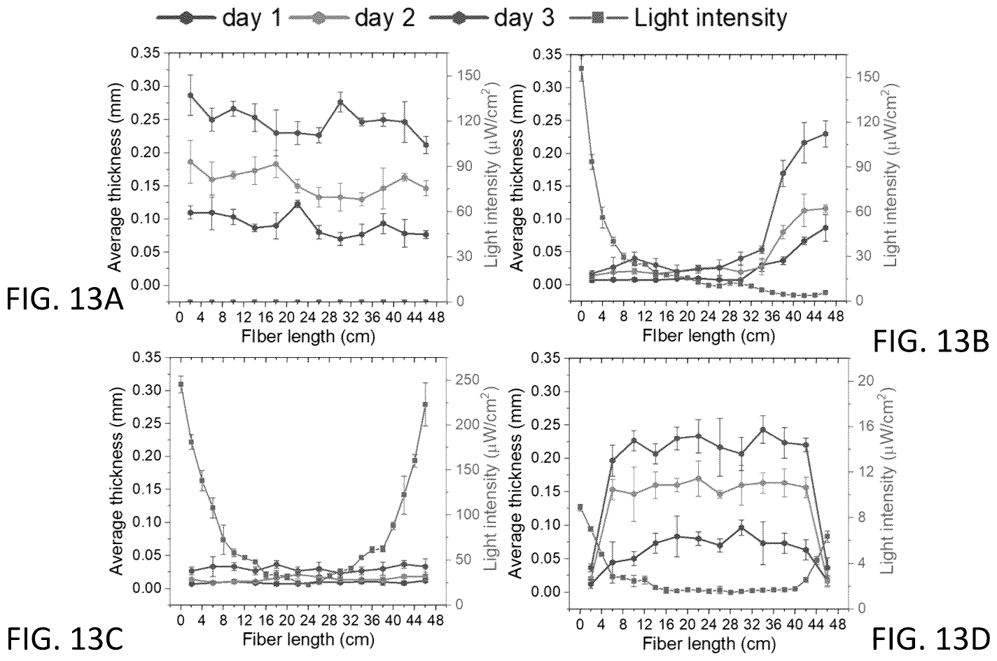

Biofilm formation in reactors exposed to UV-C irradiances were monitored in-situ through OCT. Nutrient rich media with planktonic bacteria continuously recirculated across the reactor surface. As such, there was a continuous supply of live bacteria available to attach to the surface, as well as continuous shedding of biological material from the surface due to the low shear force of the flowing water. OCT is a technique used to quantify variations in optical density, and effectively distinguishes between water, biofilms, and metal surfaces due to their distinct refractive indices. Herein OCT was employed to estimate and monitor the relative disparities in biofilm thickness during in-operando conditions (i.e., without removing biofilms from the reactor), leveraging these refractive index distinction. FIG. 13A shows the corresponding calculated average biofilm thicknesses. Because the bacterial concentration in the recirculating solution was maintained>10⁶ CFU/mL during the experiment, any differences in biofilm accumulation on the surface can be attributed to the UV-C light emitted from the SEOF. Biofilms were uniform on the surface from day 1 to day 3, approaching 0.25±0.05 mm on day 3.

Delivering UV-C light to the reactor surface significantly decreased biofilm accumulation. The UV-C irradiance (FIG. 12B) and biofilm inhibition zones (FIGS. 13A-13D) were both conical in shape, covering a larger surface area near the proximal end of the reactor and smaller surface area near the terminal end. FIG. 13B shows the calculated average thicknesses along the length of the SEOF. From L=0 cm to L=34 cm, there was a biofilm inhibition zone, where only thin biofilm formed (0.02±0.004 to 0.04±0.01 mm). There was no evidence of biofilm formation on the optical fiber surface, and the side emission from the fiber remained consistent both prior to and subsequent to the recirculation process. There was no statistically significant difference in biofilm thickness within the inhibition zone. Sufficient UV-C irradiation inhibited biofilm accumulation (i.e., near-zero thicknesses) but did not sterilize the surface.

With LEDs on both ends, I_{SEOF} levels>20 μW/cm² were achieved along the entire 50-cm length of the SEOF surface (FIG. 12C). Consequently, biofilms near the SEOF were inhibited everywhere within the reactor (FIG. 13C). To confirm the biofilm response to UV light, average thickness at 2 cm away from the SEOF was analyzed (FIG. 13D), as this location had significantly less UV-C irradiance. The obtained average thickness was consistent with previous results: biofilm was well-controlled at the ends, with irradiance equals to ˜8 μW/cm² but accumulated in all other places that had negligible UV-C irradiation (i.e., ˜2 μW/cm²).

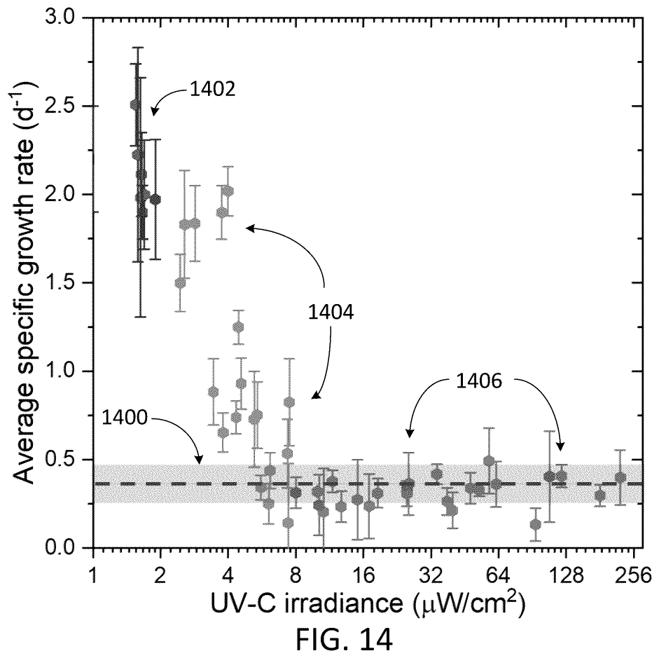

Based on biofilm growth during the experiment, biofilm specific growth rates (μ, d⁻¹) for the different UV-C irradiances were calculated based using:

$$\frac{dX ( t )}{dt} = μ X ( t ) \qquad ( 3 )$$

where X(t) is biofilm average thickness (mm) at time t (days), μ is the specific biofilm growth rate (d⁻¹), which was influenced by UV light. FIG. 14 shows the calculated biofilm specific growth rates over the 3-day experiments. Without UV-C exposure, the biofilm thickness was 0.25±0.05 mm and had an average specific growth rate of 2.2±0.3 d⁻¹ over 72 hours. Biofilm growth inhibition began (i.e., lower growth rate and average thickness) in the presence of UV-C. Biofilm growth rates with UV-C fell into three regions: 1) UV-C>8 μW/cm² where biofilm is effectively inhibited and characterized by a low growth rate (average μ value of 0.3 d⁻¹), 2) UV-C<3 μW/cm² where biofilm is poorly inhibited with statistically similar specific growth rates to that in dark control without light, or 3) a transitional UV-C range (3<UV-C<8 μW/cm²) where biofilm is partly inhibited. The point where UV-C irradiance results in biofilm specific growth rates becoming statistically different (i.e., beyond 95% confidence interval) from 0.3 d⁻¹ was considered the UV-C irradiance required to effectively inhibit biofilm; defined as UVₘᵢₙ.

Statistically similar and small biofilm thickness (i.e., 0.03±0.02 mm) and specific growth rates (i.e., μ=0.3±0.1 d⁻¹) occurred at locations within the reactor where irradiance>8 μW/cm². Further increases in UV-C irradiance did not lead to less biofilm accumulation or slower specific growth rate, indicating that distributing light energy over a larger area is more practical than focusing high-dose UV-C irradiation in a small area. Overall, surfaces exposed to >8 μW/cm² UV-C irradiance had minimal biofilm accumulation, showing OCT-based thickness near detection limits and below 0.02 mm. Values of UVₘᵢₙ are likely unique to the organism, nutrient levels, temperature, shear forces, and other conditions; while kept constant in this investigation, these conditions would likely differ under other scenarios. Because the UVₘᵢₙ effectively inhibited biofilm formation, surfaces in the reactor exposed to UV-C above 8 μW/cm² provided marginal or negligible additional benefit.

FIG. 14 shows biofilm specific growth rates in the 50-cm reactor where SEOFs delivered different UV-C irradiance to the reactor surface. Region 1400 represents the average and 95% confidence interval (μ=0.34±0.06 d⁻¹) of the specific growth rates 1402 when biofilm was effectively inhibited. Biofilm specific growth rates 1404 in the transitional range (3<UV-C<8 μW/cm²) when biofilm was partly inhibited 1404 and poorly inhibited 1406 are also shown.

Although UV-C irradiation significantly inhibited biofilm accumulation when the irradiance was >8 μW/cm², some bacteria survived in a thin biofilm layer. Biofilm samples were collected from four locations after 3 days. At the time of collection, biofilms may have contained previously deposited bacteria that were inactivated or inhibited by UV-C exposure plus bacteria recently deposited to the surface from planktonic organisms in water recirculating through the reactor. Biofilms that had no exposure to UV-C irradiation were compared with two other types of biofilms: 1) samples collected from reactor regions where biofilm was effectively inhibited by continuous UV-C intensity (i.e., 8 μW/cm²<UV-C<80 μW/cm²) or poorly inhibited (i.e., <3 μW/cm); and 2) established biofilm collected from the reactor without UV-C exposure (dark control) and then post-exposed to UV-C light (250 μW/cm² for 30 minutes). The relative abundance of sequenced mRNA read (transcripts per million (TPM)) represents a snapshot of gene expression information at the time of biofilm sample collection.

Gene expression related to ATP and NADH synthesis was plotted in heatmaps. Most genes were downregulated by 3.5- to 0.7-log₂fold for biofilms post-exposed to UV-C light. Downregulation of genes responsible for ATP and NADH synthesis demonstrates suppression of basic energy metabolism in the bacteria. Higher UV-C exposure has the potential to hinder the microbial activity of biofilms by impeding their energy metabolism. On the contrary, both inhibited biofilm samples collected from regions in the reactor where biofilms were either effectively inhibited or poorly inhibited were mostly upregulated, which suggests that surviving bacteria increased energy processing. Compared to the negative control, the divergent transcriptional responses among different UV-C exposed biofilms suggest that high UV-C exposure was required to impede the energy metabolism. The elevated energy processing resulting from inadequate UV-C exposure might conceivably play a role in driving other bacterial phenotypic responses to the UV-C exposure.

The SOS gene response is a global regulatory system that responds to DNA damage and repairs the DNA. The gene expression levels of SOS-response genes revealed complete downregulation of DNA-repairing genes in UV-C post-exposed biofilms, which suggests that exposure of a pre-established biofilm to the very high UV-C caused so much DNA damage that it inhibited DNA repair. For biofilm collected from the effectively inhibited regions, the gene encoding recombination protein RecA was 1-log₂fold upregulated, as were DNA-repair genes recO, sbcD, and uvrD. However, SOS-response genes were downregulated, which suggests that the UV-C irradiation in that area did not allow bacterial repair of DNA damage. For biofilm collected from the poorly inhibited regions, most of the DNA-repair genes were upregulated, which may have helped the bacteria to survive the DNA damage from moderate UV-C irradiation.

While a SOS gene response triggers DNA repair to overcome DNA damage, quorum sensing is another regulation system that might protect bacteria from UV-C irradiation stress by enhancing adherence, motility, extracellular matrix synthesis, and eventually biofilm formation. In quorum sensing, P. aeruginosa sense and respond to their population density using signal molecules (e.g., N-acylated homoserine lactones (acyl-HSL)). The gene expression levels of two acyl-HSL signaling systems (las and rhl) in three different zones were assessed. Both quorum-sensing systems were downregulated for biofilm samples post-exposed to UV-C light. For biofilm collected from the effectively inhibited regions, lasR/lasI and rhlR/rhlI were upregulated by 1.9/3.0-log₂fold and 2.0/0.6-log₂fold, respectively. From the poorly inhibited regions, less upregulation of the two systems was observed than in biofilms collected from effectively inhibited regions.

The upregulation of quorum sensing genes should promote biofilm formation by increasing the production of LecA/LecB lectins. LecA contributes to the P. aeriginosa biofilm formation by cross-linking galactosides on the surface of different bacterial cells. LecB binds to specific carbohydrate ligands located at the bacterial cell surface, which could enhance the adhesion of P. aeruginosa and enable colonization and biofilm formation. The gene LecA was downregulated with −2.4-log₂fold for the post-exposed biofilm and −1.0-log₂fold for biofilms collected from the effectively inhibited regions. The gene LecB was upregulated from 0 to >300 TPM for effectively inhibited regions and >100 TPM for poorly inhibited regions. LecB could be a key factor that enhance P. aeruginosa biofilm formation under the stress of UV-C irradiation.

The polysaccharide biosynthesis genes (pel and psl) were mostly downregulated for biofilm collected from the effectively inhibited regions, but they were upregulated in the poorly inhibited regions. However, the lipopolysaccharides biosynthesis genes (wbp) were upregulated for effectively inhibited regions, but they were downregulated for poorly inhibited regions. Lipopolysaccharides and polysaccharides are protective extracellular exopolysaccharides that can promote biofilm formation. The different regulation in response to irradiation suggests that higher UV-C irradiation promoted the biosynthesis of lipopolysaccharide, while lower UV-C irradiation promoted polysaccharide. The results suggest that lipopolysaccharides and polysaccharides may contribute to bacterial defense in different scenarios.

The flagellar synthesis genes were upregulated from 0.4 to 2.4-log₂fold in samples collected from the effectively inhibited regions and upregulated from 0.9 to 1.5-log₂fold in poorly inhibited regions. Bacterial flagella propel the bacterial cells and can lead to motility for the bacteria cell to escape from the stress of UV-C irradiation. UV-C post-treatment of a pre-established biofilm inhibited the expression of flagella-synthesis genes. Biofilm samples from both the effectively and poorly inhibited regions promoted motility genes in the bacteria.

Different to flagella, pili and fimbriae of bacteria promote surface adhesion. The downregulation of pili and fimbriae encoding genes (−3.4 to 0-log₂fold) for biofilms in the effectively inhibited regions suggests that bacteria were not as likely to adhere the surface. Hence, ample UV-C irradiation prevents bacterial attachment to the surface, supporting the earlier observation that OCT imaging revealed a reduced average biofilm thickness. In contrast, the pili- and fimbriae-encoding genes were upregulated by 0.1- to 1.2-log₂fold for biofilms in the poorly inhibited regions, which suggests that lower UV-C intensity promoted adherence to the surface. These responses suggest that limiting the bacteria's mobility could be a potentially effective means of mitigating biofilm.

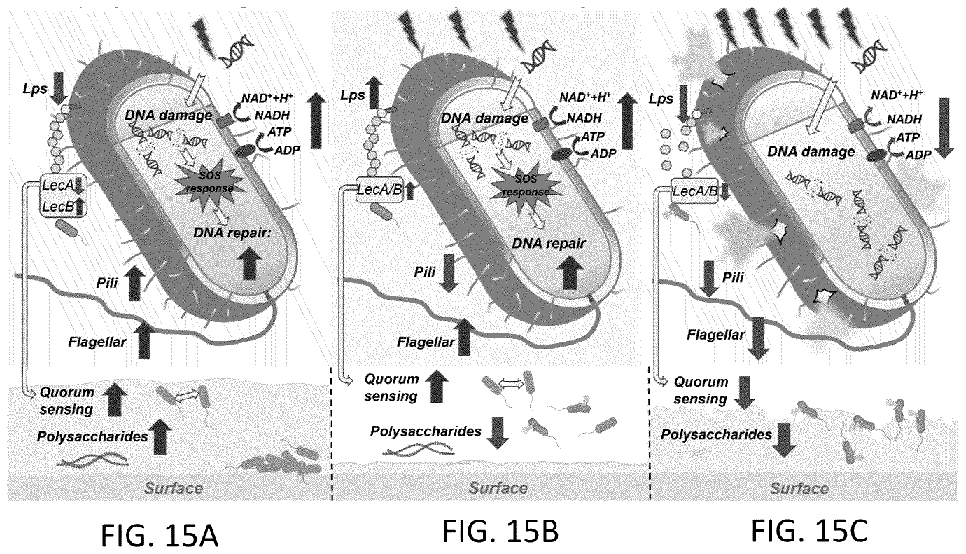

FIGS. 15A-15C summarize how P. aeruginosa biofilms responded to varying intensities of UV-C irradiation, based on the mRNA results. FIGS. 15A-15C depict P. aeruginosa biofilm response to UV-C irradiation: continuous UV-C irradiance that poorly inhibited (UV-C<3 μW/cm²), and effectively inhibited (8 μW/cm²<UV-C<80 μW/cm²) biofilm growth; and P. aeruginosa biofilm response to post-treatment by >250 μW/cm² UV-C light for 30 min, respectively. To avoid stress from UV-C irradiation, the bacteria cells expended energy to move away from a higher UV-C exposure, but they formed a biofilm in lower UV-C exposure areas. While high-intensity UV-C severely inhibited biofilm growth, insufficient UV-C triggered an SOS response and quorum sensing of P. aeruginosa that eventually promoted biofilm formation. Thus, the dramatically different transcriptional responses of biofilm to UV-C indicates that the intensity needs to be precisely controlled when UV-C is used for biofilm inhibition. The observed trends in RNA responses suggested that future mechanistic studies of UV-C biofilm inhibition should focus on DNA repair, polysaccharide biosynthesis, and bacterial mobile organelles.

A barrier in some biofilm applications with UV-C light is how to deliver the light to surfaces where biofilms exist. Here, UV-C SEOFs were applied to a pressurized water system with flowing water. These conditions closely mimic real-world conditions live planktonic bacteria being continuously deposited to surfaces where biofilms could colonize, as well as resulting in hydraulic shear of live or inactivated cells and biofilm materials from the surface. Investigating the relationship between biofilm growth rate and UV-C inhibiting rate in this system suggested three crucial regimes can occur in systems relying upon UV-C light for biofilm control. Effective inhibition zones have sufficient UV-C light intensity (e.g., 8 μW/cm² with growth media and P. aeruginosa planktonic level) to avoid biofilm formation. A transitional zone, where biofilms may form and bacteria on the surface experience ROS stress and have physiological responses that may help mitigate UV-C damage, exists (e.g., approximately 3 to 8 μW/cm²). Lower UV-C intensities appear ineffective in curtailing the growth of biofilms. The three ranges of UV-C intensities may not be universal to any water system, and likely depend upon the types of bacteria, nutrient conditions, transmittance of the water, water temperature, fluid shear and mode of light delivery (e.g., continuous versus intermittent duty cycling of light).

### Example 3

This example describes scalable manufacturing processes that negate the need of nanoparticle deposition on the optical fiber surface in continuous-production drop towers, yet readily achieves tunable UV-C side emission fluence rates (μW/cm²) and maintains the physical flexibility of SEOFs that allows them to fit into surfaces with complex geometries where biofilms grow. First, a ray-tracing model developed for the LED source and optical fiber system based on Snell's law and Mie scattering principles confirmed that increasing the surface roughness of SEOFs enhances the side emission of UV-C light from glass fibers coated with UV-C transparent polymers. A subtractive engineering process using a specially selected solvent was applied to the commercial-scale 500 μm glass fiber which altered the outer UV-C transparent polymer surface roughness and resulted in changes of tensile strength and UV-C side-emission from the fiber once attached to a 275 nm LED. Second, an application was conducted and successfully demonstrated biofilm inhibition using modified SEOFs inside curved tubing with flowing water to represent a point-of-use application. The results demonstrate a SEOF manufacturing process and the effectiveness of SEOFs in regulating irradiance levels and delivering UV-C energy for the control of biofilm growth in confined geometries, such as small-diameter tubing systems.

Continuous lengths (1000 meter) of commercially available solarized quartz optical fibers with core diameter of 498±0.65 μm (range: 495.7 μm minimum to 500.5 μm maximum) were manufactured by Polymicro/Molex (AZ, USA) in a full-scale draw/drop tower with the following characteristics: 1.51 core refractive index, 0.39 Numerical Aperture. In the drop-tower a uniform 15 μm thick CyTop™ polymer layer (BELLEX International Crop, Wilmington, DE) was coated on fiber to result in an outer fiber diameter of 528±0.63 μm.

Surface roughness on the full-scale manufactured CyTop™-coated fibers was induced by etching into this polymer coating using a solvent, in an off-line processing chamber. CyTop™ is a durable material, resistant to most acids, bases and solvents; after evaluating 15 types of solvents, only one solvent (perfluorotributylamine, 95%, (ThermoFisher, A19126)) could modify the polymer surface. While containing organo-fluorine, neither CyTop™ nor the solvent perfluorotributylamine (PFTBA) contains or releases per- or poly-fluoroalkyl substances. PFTBA has low toxicity and is used as a component (Fluoso™) in artificial blood. The full-scale manufactured CyTop™-coated fibers were submerged into the solvent for 0.5 to 5 hours before connected to UV-LEDs, resulting in different degrees of surface roughness that were termed low, medium, and high surface roughness modifications. The solvent treatment was done before launching UV into the fiber, and therefore no harmful chemicals or by-products were formed or released during UV irradiation.

A cleaver (VytranFiber Cleaver, Thorlabs, NJ) was used to cut the fiber to 30 cm or 1 m lengths with a uniform and clean surface verified by an inspection microscope (FS201, 200X, Thorlabs, NJ). SEOFs were mounted into a SMA905 connecter and connected to an 80 mW UV-C LED driver (PearlLab FiberBeam™, Aquisense Technologies, KT, USA); this system has a separation distance of 1-mm between the LED chip face and cleaved surface of the optical fiber.

Light irradiance (μW/cm²) emitted from the LED, launched into a fiber, side-emitted from the surface (I₀) of a SEOF or exiting the terminal end of the fiber (I_{T}) was measured by an optical spectrophotoradiometer (8-mm tip diameter, AvaSpec-2048L, Avantes, CO) with a connected Cosine Corrector (CC) that allows for diffuse light collection over 180 degrees incidence. Measurements were conducted along the length (x) of the fiber or distance (d) perpendicular to the fiber surface. Measurements were performed on original manufactured fiber and fibers with differing decreases of surface roughness modifications. A UV-C dose at surface was calculated using:

UV-C dose(mJ/cm²)=Light irradiance(mW/cm²)×Irradiation time (sec) (4)

To determine the radial side-emitted away from the SEOF, light irradiance measurements were made using the radiometer on the fiber surface (I₀) and at 0.5 cm, 1 cm, 1.5 cm, and 2 cm distances perpendicular to the fiber surface. These measurements were made through air as the medium. The measured irradiances were fitted to the following exponential equation to obtain the light irradiance of side-emitted light at other locations away from the fiber surface:

I(μW/cm²)=I₀e^{-kd} (5)

where I(μW/cm²) is the light irradiance at the distance d (cm) perpendicular to the SEOF and k(cm⁻¹) is the attenuation coefficient through air. The cumulative power output (mW) side emitted along the SEOF was calculated using the length (L, cm) and diameter (D, cm) of optical fiber:

Power(mW)=πDL∫₀^{L}I(x)dx (6)

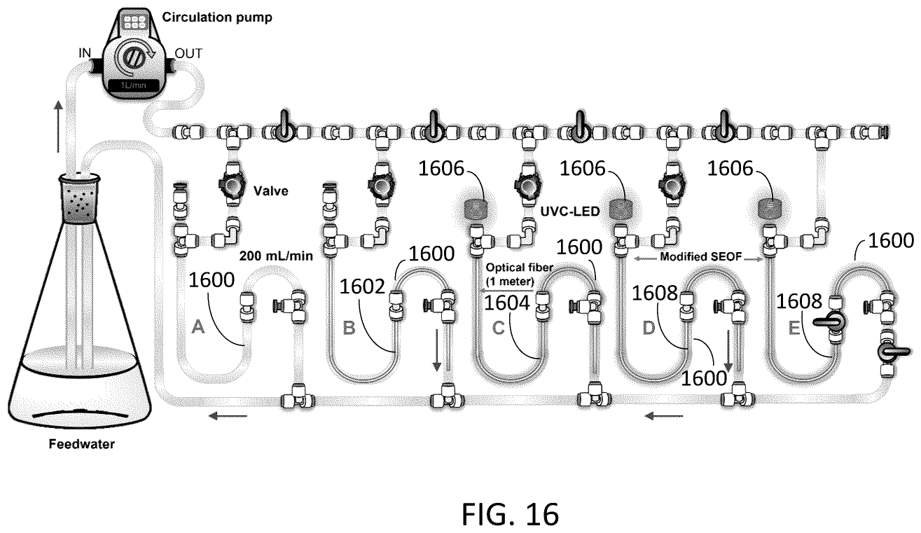

FIG. 16 shows the experimental set-up for a pressurized tubing system. A feedwater stock reactor (4 L) containing 0.1×M9 medium spiked with P. aeruginosa. Two separate experiments with initial feedwater concentration of 10^{3.9±0.07} CFU/mL and 10^{5.9±0.1} CFU/mL were performed to grow biofilm at low and high bacterial density, respectively. The size of standard household POU plumbing (i.e., water heater, bathroom/kitchen sink) ranges from 0.5-cm to 1.9-cm, therefore, 1-cm tubing size was chosen in this work. A single pump recirculated feedwater continuously through 5 parallel tube reactors (1 cm diameter; 1 meter length; polypropylene). Polypropylene was selected because it is commonly used in household POU plumbing. A needle valve controlled flow through each tube reactor, which was set at 200 mL/min and could be monitored by an in-line flowmeter. Each 1-meter-long polypropylene tube reactor included two 180° bends to simulate potential realistic POU applications where a flexible SEOF may be more appropriate than a single point-source of light. SEOFs were inserted into tube reactors.

FIG. 16 shows, from left to right, the following five parallel tube reactor configurations: A) one control including tube 1600 without SEOF; B) one control with SEOF 1602 that was not irradiated (i.e., no LED) inside tube 1600; C) one non-modified SEOF 1604 in tube 1600 and coupled to LED 1606 to represent a lower-irradiation UV-C dose condition; D) and E) are identical replicates with two medium-roughness modified SEOFs 1608 inside tubes 1600 and coupled to LEDs 1606 to represent a higher-irradiation UV-C dose condition. Experiments involved continuous flow of water through the tube reactors for 1 to 7 days. At the end of each experiment the 1 m tube pipe sections were removed from the quick-disconnects, cut using a sterilized razor into 10 equal length coupons (3 cm) every 10 cm apart. Each coupon was separately sonicated for 15 minutes to dislodge biofilm from the surface into the PBS solution. Dislodged bacteria were cultured and enumerated on LB agar plates, and then data used to calculate the biofilm density (CFU/cm²) on the 3 cm section of tubing.

A MATLAB ray-tracing model using the above principles was developed to simulate the effects of surface roughness on the light side-emitted from the optical fibers. The fiber simulated was 500 μm in diameter, with a 15 μm coating. To investigate if surface roughness of the smooth polymer coating induced side-emission, a surface deviation function is defined:

y(x)=A*sin(2*pi*f*x)+random (7)

where A is the amplitude of the wave (μm), f is the frequency (cm⁻¹), and x is the length along the fiber. The surface deviation function is intended to depict surface roughness through waviness and random noise functions of the surface profiles height and variance. The ‘random’ variable is defined using the MATLAB function, which provides random numbers within a normal distribution between 0 and 1. The frequency of random variation application was also considered; a surface that is too noisy could allow more light than desired to side emit in the first few centimeters of the fiber and is unlikely to represent a genuine surface texture. Thus, different conditions were set up such that there would be a deviation of the amplitude, or half the amplitude, only if the roughness output was within the bounds of the condition statement.

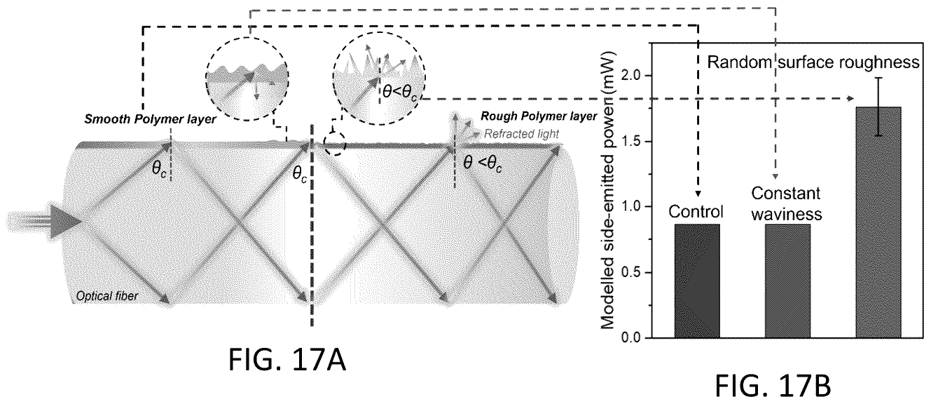

While altering the surface roughness of a glass fiber could introduce defects that might compromise its bending or tensile strength, that increasing the roughness of the SEOFs was thought to enhance the side emission of UV-C light with minimal impact on the strength of the glass+polymer SEOF. This hypothesis is supported by principles in optical physics (illustrated in FIG. 17A), demonstrating that introducing surface roughness enables lower-angle light, that would normally undergo Total Internal Reflection (TIR), to instead emit from the side. The LED chip face emits non-collimated light at different angles, which will enter the SEOF. Snell's Law (Equation 8) dictates that when light reaches the boundary between two different materials, angle of the incoming ray makes with the boundary surface normal, θᵢ, and the refractive indices of the polymer medium and air medium—nₚ and nₐ, respectively-dictates the transmitting angle of light, θₜ. If the critical angle, θ_{c}, (Equation 9) is exceeded by the incoming ray, the light will experience TIR and be unable to side emit.

$${n}_{f} sin ( {θ}_{i} ) = {n}_{a} sin ( {θ}_{t} ) \qquad ( 8 )$$

$${θ}_{c} = a sin ( \frac{{n}_{a}}{{n}_{p}} ) \qquad ( 9 )$$

Adding surface roughness changes the surface normal to the boundary between the fiber and air mediums. Thus, a light ray that would nominally undergo TIR may interact with a part of the boundary altered by surface roughness and have a θᵢ<θ_{c}, thus causing transmittance out of the fiber, and a change in direction in the reflected ray that can lead to further transmittance through the boundary.

Hundreds of model simulations were performed using a range of surface roughness parameter values. The model formulation represents a first approximation for the potential enhancements of UV-C side emission from the optical fibers, rather than a physical model of all the various types of surface imperfections that could exist (e.g., pitting, valleys, cracks). The surface roughness model outputs were compared to an idealized non surface modified fiber with a smooth polymer outer layer. Surface roughness modeling outcomes showed the potential enhancements in UV-C side-emission if optical fibers had a rough (not smooth) outer surface. FIG. 17B shows a key insight from these simulations, that “constant waviness”, or Equation 9 without the “random” variate, does not increase side emission regardless of amplitude or frequency changes. In FIG. 17B, the total 275 nm power side-emitted from a modeled optical fiber could emit a small amount (0.8 mW) of energy; the “constant waviness” simulations likewise showed only 0.8 mW of side-emitted power. The scale of the wave amplitude was significantly smaller than the wave period, and the fidelity of the simulation is limited by computed power, so on average, the maximum incident angle differences were negligible, and the output power averaged out to have negligible differences from the control simulation. However, applying equation 9 with various conditions resulted in an average of 1.8 mW of side-emitted power for 60 separate conditional trials. Each conditional trial was run in triplicate and averaged; the 99% confidence interval power ranges between 1.6 to 2 mW. Even within the inherent model limitations, there is a wide range of possible power emitted, and the modeled rough fiber is highly likely to provide at least double the power of the “smooth” fiber. Therefore, based on the optical theory discussed above and findings from the model, w surface roughness was experimentally induced on SEOFs for higher side emission, and the relationship between side emission, flexibility and surface biofilm mitigation was observed.

To test the hypothesis supported by the model, a “subtractive engineering” synthesis method was explored to induce surface roughness on the outer CyTop™ polymer layer of the SEOF. Varying the exposure duration of the SEOF to the selected solvent (perfluorotributylamine) lead to more CyTop™ dissolution, and hence induced surface roughness. These changes were monitored using SEM and optical profilometer measurements.

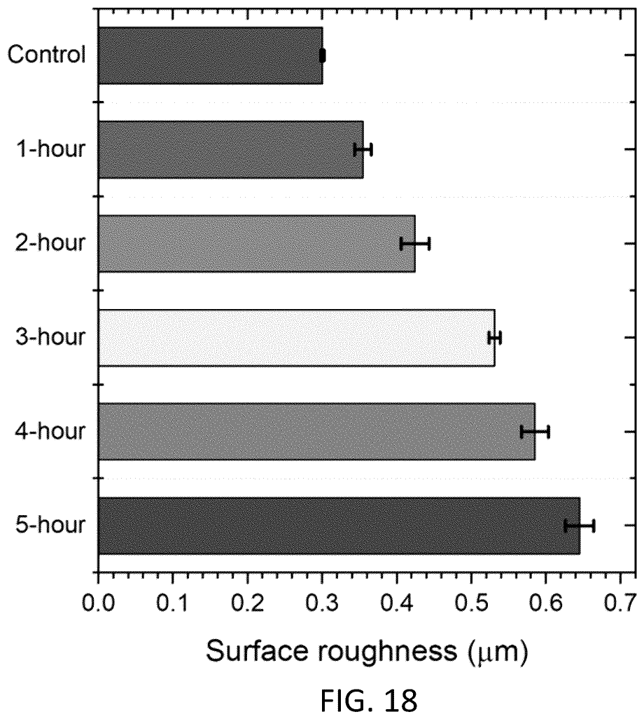

Imaging of the fiber surface was used to quantify a surface roughness parameter (SR). SEM, and optical profilometer measurements are shown FIG. 18. The original coating had a very low SR value of 0.3±0.02 μm, which is consistent with on-line optical measurements made in the draw tower. Treating the SEOF with different durations in the solvent creates rougher surface increased SR value from 0.3±0.02 μm to 0.65±0.03 μm.

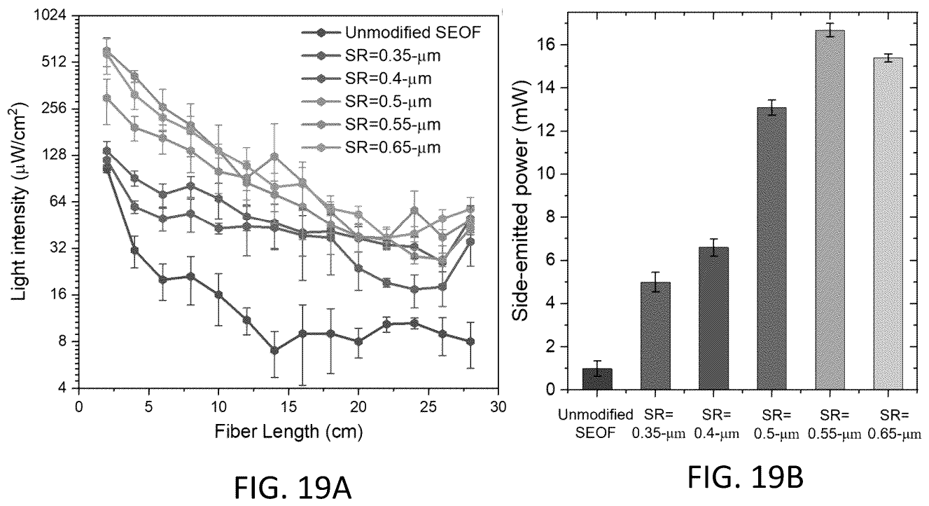

FIG. 19A shows the amount of side-emitted light irradiance measured along the length of the SEOF for each surface modified SEOF. There was greater side-emission along the entire length of all surface-modified fibers, compared against the as-received unmodified (control) fiber. The as-received unmodified (control) fiber (SR=0.3±0.02 μm) side emits 124±6 μW/cm² at the proximal end and declines exponentially to 8±2 μW/cm² at the terminal end. In contrast, after the longest treatment time (5-hr) which achieved a SR ˜ 0.6 μm the side-emitted light increased by 4× to 5× (610±120 μW/cm²) at the proximal end and greater than 7× at the (57±11 μW/cm²) at terminal end.

Surface roughness had a beneficial impact and increased UV-C light side emitted from the SEOF. In FIG. 19B the cumulative integrated power output (Equation 6) is presented for a 30-cm fiber with varying SR values. Side emission reaches a plateau when SR exceeds 0.5 μm, with further increases in roughness not significantly enhancing side emission. Based on the observed increase of side emission at each SR value, low (SR=0.3 to 0.4 μm), medium (SR=0.4 to 0.5 μm), and high (SR>0.5 μm) roughness ranges are defined for different subtractive engineered SEOFs to achieve variable (i.e., tunable) irradiance of side-emitted light.

Based upon increased side-emitted light intensity, higher SR is desirable. However, modified SEOFs with higher SR were physically more brittle and less flexible. Tensile tests were performed for each fiber to determine the effect of surface roughness on the tensile strength. The tensile load-elongation response of the fibers up to the failure load was investigated. The axial force to break the fiber by axial pulling on two ends of the fiber was used to compute the nominal tensile strength using a diameter of 500 μm. The as-received fiber with a uniform polymer coating had a tensile strength of 750 MPa. SEOFs with SR ranged from 0.35 μm to 0.5 μm showed a degradation in strength to 650 and 540 MPa, respectively. For the two most brittle samples, no statistically significant difference in tensile strength between high roughness and bare glass fiber without polymer was observed. In order to correlate the tensile strength to allowable compliance of a fiber subjected to bending in tubes, flexibility measurements were conducted by bending the fibers with SEOFs with varying SR values around a circular mandrel of various sizes in sequence. Higher bending capacity is observed by higher curvature. SEOFs with SR ranged from 0.35 μm to 0.5 μm met a mean curvature of 0.1-0.2 mm⁻¹ criterion, which is sufficiently compliant to be fitted into nearly all water systems. Further increasing the roughness decreases the flexibility, such that there was no statistical difference to the bare glass fiber's tolerance of diameter. Overall, introducing low or medium SR (SR<0.5 μm) onto a polymer cladded fiber increases the side emission and preserves flexibility. The flexibility (i.e., able to bend around a 1 cm radius curve) of the modified SEOF is suitable for many water applications (i.e., bends in domestic plumbing and inside of POU reactors).

To demonstrate that SR modified fibers are flexible enough to be used in narrow geometry water systems and perform superior to non-modified fibers in controlling biofilms, recirculating pipe-loop experiments were performed. The light intensity from SEOFs was measured as they were bent inside the tubing. The measurements were taken through 3 cm holes located every 10 cm length along the pipelines, enabling the radiometer to access the interior of the tube. There was not more side-emitted light at the bends than along straight sections of the SEOF. Reactor A and B are dark control experiments without and with fiber, respectively. Reactor C was equipped with an as-received glass plus polymer coated optical fiber (SR=0.3 μm), which emits>10 μW/cm² along the first 30 cm length and <3 μW/cm² between 30 to 100 cm. Reactor D and E are duplicate systems, equipped SEOFs having medium-SR that provided>10× higher and significantly more uniform side emission than the as-received fiber; side-emitted light was 55±7.5 μW/cm² at the proximal end and 25±2.5 μW/cm² at the terminal end.

The side emitted light intensity at the wall inside the tubing was calculated using Equation 5. To determine the attenuation coefficient, the light irradiance perpendicular to the fiber surface was measured using 25 optical fibers with different initial light intensities. The distance between optical fiber and pipeline inner surface could range from 0-0.5 cm; hence, the minimum and maximum light intensity inside reactor D and E is 11 μW/cm² (distance=0.5 cm at the terminal end) and 55±7.5 μW/cm² (distance=0 cm at the proximal end), respectively. These values were measured in air using the radiometer, which could potentially introduce bias when applied to different media. Nevertheless, when accounting for refractive index variations and potential differences in UV attenuation across various media, it is expected that the UV-C irradiance reaching the surface should remain within the same order of magnitude in water for these small diameter tubes.

The amount of biofilm (CFU/cm²) on each 10-cm inside section of tubing was measured. Without UV-C exposure, a uniform ˜800 CFU/cm² biofilm (10^{2.9±0.12} CFU/cm²) formed in Reactors A and B (p=0.066). In Reactor C, biofilms remained below the EPA recommended limit of 100 CFU/cm² for potable water systems within the first 20 cm of tubing, where the calculated wall irradiance was ˜4.5 μW/cm² based on Equation 6, which was based upon air as the medium. Between 20 to 100 cm of tubing in Reactor C, 100-800 CFU/cm² was measured along the length. There was no statistical difference about biofilm formation at terminal end in Reactor C and dark control (Reactors A or B). At all locations in both duplicate tubing systems with surface modified SEOF (i.e., Reactors D and E), the measured biofilm density was ˜10 CFU/cm² (10^{0.68±0.5} CFU/cm²) and below the EPA recommended level. In summary, when the UV-C light intensity, as measured by the radiometer in air, exceeded 4.5 μW/cm², the resulting irradiance in water resulted in approximately a 2-log reduction in live bacteria within biofilms at the wetted surface of the tube walls.

Biofilm formation and growth or accumulation rates can be related to the planktonic bacterial levels in water flowing through piping systems. It is believed that the UV-C inhibition rate should be larger than the biofilm growth rate to control microbial growth on surfaces. Therefore, a second set of pipe-loop tests were performed using feedwater containing a higher P. aeruginosa planktonic level (>10⁵ CFU/mL during recirculation). The same as-received and surface modified fibers were used. The biofilm formation in each reactor with a higher bacterial concentration was assessed. Biofilm (1000 CFU/cm²) in Reactors A and B were higher using this feedwater, which had a planktonic level of >10⁵ CFU/mL. All three reactors with surface modified SEOFs had lower biofilm densities than the control reactors, and followed the same trends as observed with the lower P. aeruginosa planktonic levels. A reduction of more than 1-log in biofilm density was observed in all reactors when an intensity exceeding 4.5 μW/cm², as measured in air, was delivered to the wetted surface. However, a lesser degree of inhibition was noted for intensities below 4.5 μW/cm². However, the SEOFs did not inhibit biofilms to the same extent (i.e., <100 CFU/cm²) as in experiments with the lower P. aeruginosa planktonic levels.

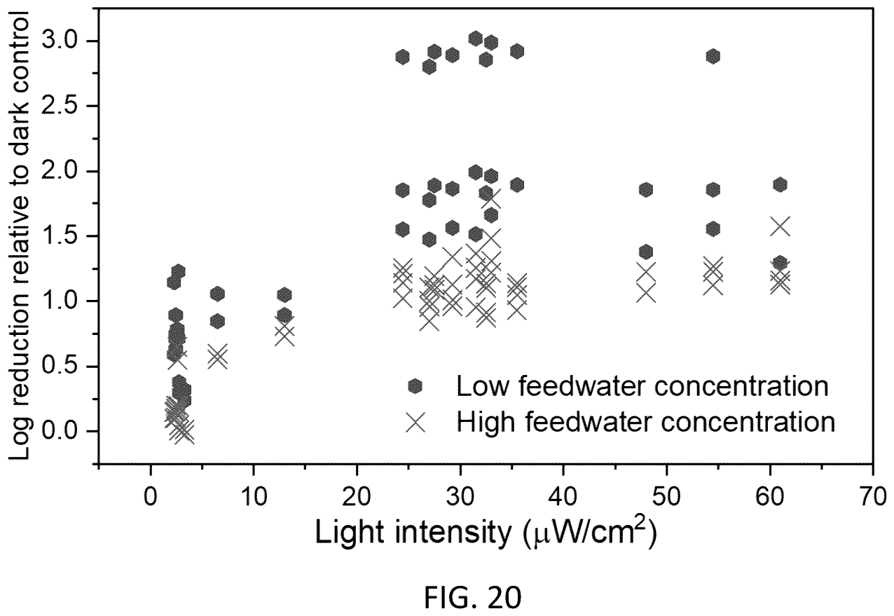

To integrate data from the two pipe-loop studies, the log-reduction in live biofilm density by UV-C(compared to non-irradiated controls) was combined across all experiments. FIG. 20 illustrates the resulting trend, indicating that delivering more than 10 to 20 μW/cm² from the SEOF to the tube wall led to a reduction of over 1-log in biofilm growth compared to the controls. This finding is particularly relevant in continuously recirculating systems, suggesting that higher UV-C irradiance levels may be necessary to maintain sufficient inactivation rates relative to the net growth rates of planktonic bacteria populations capable of continuous surface deposition. In drinking water systems, it is uncommon to have concentrations exceeding even 10⁴ CFU/mL.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composite material comprising:
one or more side-emitting optical fibers arranged in a pattern defining openings bounded at least in part by the one or more side-emitting optical fibers, wherein the one or more side-emitting optical fibers have a UV-C transparent coating, and
at least one of the one or more side-emitting optical fibers is configured to be coupled to a light-emitting diode.

2. The composite material of claim 1, wherein the composite material comprises a woven or non-woven fabric of the one or more side-emitting optical fibers.

3. The composite material of claim 1, wherein the one or more side-emitting optical fibers have a diameter in a range of about 100 μm to about 1000 μm.

4. The composite material of claim 1, wherein a length of the one or more side-emitting optical fibers is in a range of about 20 cm to about 1 km.

5. The composite material of claim 1, wherein the pattern comprises a mesh, a lattice, a matrix, or a network.

6. The composite material of claim 1, wherein the openings have a geometrical shape.

7. The composite material of claim 6, wherein the geometrical shape is a rectangle or a parallelogram.

8. The composite material of claim 1, wherein a linear dimension of each opening exceeds a diameter of the one or more side-emitting optical fibers.

9. The composite material of claim 1, wherein the composite material is in the form of a sheet.

10. The composite material of claim 9, wherein a thickness of the sheet is in a range of about 0.5 mm to about 1.5 mm.

11. The composite material of claim 1, wherein the one or more side-emitting optical fibers comprise a multiplicity of bundled side-emitting optical fibers.

12. A filter comprising the composite material of claim 1.

13. A water tank comprising the composite material of claim 1.

14. A spacer for a reverse osmosis filter comprising the composite material of claim 1.

15. A reverse osmosis filter comprising:
a reverse osmosis membrane; and
the composite material of claim 1 coupled to the reverse osmosis membrane.

16. The reverse osmosis filter of claim 15, wherein the composite material is in direct contact with the reverse osmosis membrane.

17. The reverse osmosis filter of claim 15, wherein the reverse osmosis membrane and the composite material are spirally wound.

18. The reverse osmosis filter of claim 17, wherein the composite material provides gaps between layers of the reverse osmosis membrane.

19. The reverse osmosis filter of claim 18, wherein the gaps promote turbulence in a fluid flowing through the filter.

20. The reverse osmosis filter of claim 18, further comprising a UV-C light-emitting diode exterior to the reverse osmosis filter and optically coupled to one or more of the side-emitting optical fibers.
